(19) United States
(12) Patent Application Publication
(10) Pub. No.: US 2025/0175038 A1
(43) Pub. Date: May 29, 2025

(54) CHARGING DEVICE AND CHARGING METHOD

(71) Applicant: Panasonic Automotive Systems Co., Ltd., Kanagawa (JP)

(72) Inventors: Masahiro SEO, Osaka Fu (JP); Osamu IWABUCHI, Kanagawa Ken (JP)

(73) Assignee: Panasonic Automotive Systems Co., Ltd., Kanagawa (JP)

(21) Appl. No.: 19/037,557

(22) Filed: Jan. 27, 2025

Related U.S. Application Data
(63) Continuation of application No. PCT/JP2023/028983, filed on Aug. 8, 2023.

(30) Foreign Application Priority Data
Aug. 25, 2022 (JP) 2022-134254

(51) Int. Cl. H02J 50/90; H02J 50/10

(52) U.S. Cl. CPC H02J 50/90; H02J 50/10

(57) ABSTRACT

A charging device includes a power transmitter coil, detector coils, a moving mechanism, and a controller. The controller controls the power transmitter coil, the detector coils, and the moving mechanism. The controller outputs a transmitted signal for generating a magnetic field for detection. The transmitted signal is output selectively and sequentially to each of the detector coils. The controller specifies a position of a power receiver based on received signals that are responded from the power receiver in reaction to the magnetic field of detection and are detected by each of the detector coils. The controller specifies the position of the power receiver in accordance with a relative distance between a first position of the power receiver and the power transmitter coil. The first position is the position specified based on the received signals.

### CROSS-REFERENCE TO RELATED APPLICATIONS

This application is a continuation of International Application No. PCT/JP2023/028983, filed on Aug. 8, 2023, which claims the benefit of priority of the prior Japanese Patent Application No. 2022-134254, filed on Aug. 25, 2022, entire contents of which are incorporated herein by reference.

### FIELD

The present disclosure relates to a charging device and a charging method.

### BACKGROUND

A device that wirelessly charges a terminal device with a built-in battery has been known. For example, there is disclosed a device that moves a power transmitter coil to a position of a terminal device and wirelessly charges the terminal device with the power transmitter coil (refer to, patent literatures JP 2014-128055 A, JP 2013-118720 A, etc.).

However, in the related art, it may be difficult to specify the position of a power receiver of the terminal device with high accuracy.

### SUMMARY

A charging device according to one aspect of the present disclosure is a charging device that wirelessly charges a terminal device placed on a placement surface. The terminal device includes a power receiver serving to receive wirelessly transmitted power. The charging device includes a power transmitter coil, detector coils, a moving mechanism, and a controller. The power transmitter coil is configured to transmit power to the terminal device. The detector coils are provided for detecting a position of the power receiver of the terminal device on the placement surface. The moving mechanism is configured to move the power transmitter coil. The controller is configured to control the power transmitter coil, the detector coils, and the moving mechanism. The controller is configured to output a transmitted signal for generating a magnetic field for detection. The transmitted signal is output selectively and sequentially to each of the detector coils. The controller is configured to specify the position of the power receiver based on received signals. The received signals are responded from the power receiver in reaction to the magnetic field of detection and are detected by each of the detector coils. The controller is configured to specify the position of the power receiver in accordance with a relative distance between a first position of the power receiver and the power transmitter coil. The first position is the position of the power receiver specified based on the received signals.

### BRIEF DESCRIPTION OF DRAWINGS

FIG. 1 is a diagram illustrating an example of a schematic configuration of a charging system according to an embodiment;

FIG. 2A is a schematic diagram of an example of an arrangement of detector coils;

FIG. 2B is a schematic diagram of an example of an arrangement of detector coils;

FIG. 3 is a hardware configuration diagram of an example of a controller;

FIG. 4 is a schematic diagram of an example of a circuit configuration of a charging device;

FIG. 5 is a schematic diagram illustrating an example of a basic concept of position specification of a power receiving unit;

FIG. 6 is a schematic diagram illustrating an example of a timing chart;

FIG. 7A is an explanatory diagram of an example of specifying the position of the power receiving unit by basic position specifying processing;

FIG. 7B is an explanatory diagram of an example of specifying the position of the power receiving unit by basic position specifying processing;

FIG. 8A is an explanatory diagram of an example of a relationship between a relative distance and a level of a received signal;

FIG. 8B is an explanatory diagram of an example of a relationship between a relative distance and a level of a received signal;

FIG. 9 is a flowchart illustrating an example of a procedure of information processing executed by the controller according to the embodiment;

FIG. 10 is a flowchart illustrating an example of a procedure of first position specifying processing;

FIG. 11A is an explanatory diagram of an example of an effect of the first position specifying processing;

FIG. 11B is an explanatory diagram of an example of an effect by the first position specifying processing;

FIG. 12 is a flowchart illustrating an example of a procedure of second position specifying processing;

FIG. 13A is a flowchart illustrating an example of a procedure of third position specifying processing;

FIG. 13B is an explanatory diagram of a correction coefficient;

FIG. 14A is an explanatory diagram of an example of fourth position specifying processing;

FIG. 14B is an explanatory diagram of an example of the fourth position specifying processing;

FIG. 14C is an explanatory diagram of an example of the fourth position specifying processing;

FIG. 15 is a schematic diagram illustrating an example of a timing chart;

FIG. 16A is an explanatory diagram of an example of specifying a third position;

FIG. 16B is an explanatory diagram of an example of specifying a fourth position;

FIG. 16C is an explanatory diagram of an example of specifying the fourth position;

FIG. 17 is a flowchart illustrating an example of a procedure of the fourth position specifying processing;

FIG. 18A is an explanatory diagram of an example of an effect of the fourth position specifying processing;

FIG. 18B is an explanatory diagram of an example of an effect by the fourth position specifying processing;

FIG. 18C is an explanatory diagram of an example of an effect of the fourth position specifying processing;

FIG. 19 is a flowchart illustrating an example of a procedure of information processing executed by a controller according to a modification;

FIG. 20 is a flowchart illustrating an example of a procedure of the information processing executed by the controller according to the modification;

FIG. 21 is a flowchart illustrating an example of a procedure of the information processing executed by the controller according to the modification; and

FIG. 22 is a flowchart illustrating an example of a procedure of the information processing executed by the controller according to the modification.

### DETAILED DESCRIPTION

Hereinafter, embodiments of the present disclosure will be described in detail with reference to the drawings as appropriate.

However, unnecessarily detailed description may be omitted.

Note that the accompanying drawings and the following description are provided for those skilled in the art to fully understand the present disclosure, and the subject matter described in the claims is not limited by these.

### First Embodiment

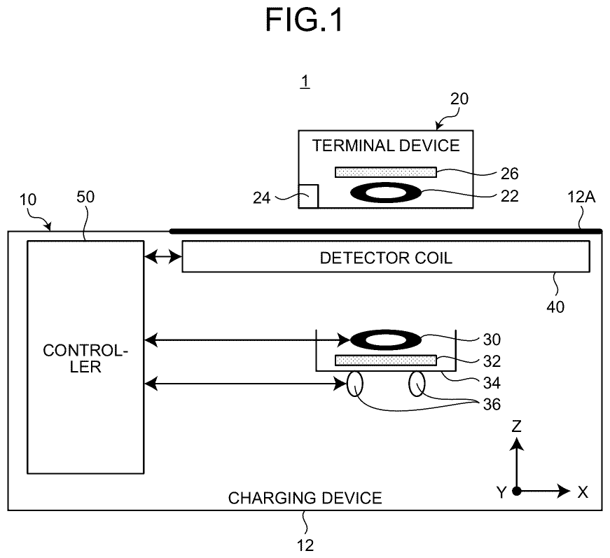

FIG. 1 is a diagram illustrating an example of a schematic configuration of a charging system 1 according to an embodiment.

The charging system 1 includes a charging device 10 and a terminal device 20.

The charging device 10 is a device that wirelessly charges the terminal device 20 in which a battery 24 is incorporated.

Wireless charging means performing charging in a wireless state. In the present embodiment, a mode in which wireless charging means charging by electromagnetic induction will be described as an example.

The terminal device 20 is a device in which the battery 24 is incorporated. The terminal device 20 is, for example, a smartphone, a tablet terminal, an audio player, a mobile phone, or the like.

The terminal device 20 includes at least a power receiving unit 22 (an example of the power receiver) and the battery 24.

The power receiving unit 22 is a mechanism that receives power wirelessly transmitted from the charging device 10. The power receiving unit 22 is, for example, an induction coil electromagnetically coupled to a power transmitter coil 30 of the charging device 10 to be described later. The battery 24 is charged by the power induced in the power receiving unit 22.

A magnetic body sheet 26 is provided on the back surface of the power receiving unit 22. The occurrence of malfunction of various electronic circuits provided in the terminal device 20 is suppressed by the magnetic body sheet 26.

A housing 12 of the charging device 10 is provided with a placement surface 12A. The placement surface 12A is a surface on which the terminal device 20 to be wirelessly charged is placed. In the present embodiment, as an example, a description will be given as to a mode in which the placement surface 12A is a partial region of the outer surface of the housing 12 and is a two-dimensional planar region.

In the present embodiment, a description will be given on the assumption that the placement surface 12A is a two-dimensional plane along a plane defined by a first direction and a second direction orthogonal to the first direction. In addition, as illustrated in FIG. 1, a description will be given on the assumption that the first direction is the X-axis direction and the second direction is the Y-axis direction. The X-axis direction and the Y-axis direction are directions orthogonal to each other along the two-dimensional plane of the placement surface 12A. A description will be given on the assumption that the Z-axis direction orthogonal to the X-axis direction and the Y-axis direction coincides with a thickness direction of the housing 12. The Z-axis direction coincides with the facing direction of the terminal device 20 and the charging device 10 placed on the placement surface 12A.

In the housing 12 of the charging device 10, the power transmitter coil 30, plural detector coils 40, a moving mechanism 36, a controller 50, and the like are provided.

The power transmitter coil 30 is a coil for transmitting power to the terminal device 20. Specifically, the power transmitter coil 30 is a coil for generating an AC magnetic field for charging and supplying power to the power receiving unit 22 by electromagnetic induction with the power receiving unit 22 of the terminal device 20.

A magnetic body sheet 32 is provided on the back surface of the power transmitter coil 30. The magnetic body sheet 32 prevents the AC magnetic field generated by the power transmitter coil 30 from affecting various electronic circuits provided in the region on the opposite side of the detector coil 40 with respect to the power transmitter coil 30 in the charging device 10. In addition, by the magnetic body sheet 32, power due to the AC magnetic field generated by the power transmitter coil 30 is effectively supplied to the power receiving unit 22. That is, the magnetic body sheet 32 contributes to prevention of malfunction of various electronic circuits provided in the charging device 10 and improvement in power transmission efficiency from the power transmitter coil 30 to the power receiving unit 22.

In the present embodiment, the power transmitter coil 30 is placed on a conveyance table 34 via the magnetic body sheet 32.

The moving mechanism 36 is a mechanism that moves the power transmitter coil 30 along the placement surface 12A. In the present embodiment, the moving mechanism 36 moves the conveyance table 34 on which the magnetic body sheet 32 and the power transmitter coil 30 are placed in this order along the placement surface 12A, thereby moving the power transmitter coil 30 placed on the conveyance table 34 along the placement surface 12A together with the magnetic body sheet 32.

The moving mechanism 36 includes one or more drive motors such as stepping motors, a support member, and the like. The moving mechanism 36 is configured to move the conveyance table 34 along the placement surface 12A in the X-axis direction and the Y-axis direction by driving of a drive motor. That is, the power transmitter coil 30 is configured to be movable along a two-dimensional plane formed of the XY plane along the placement surface 12A by the moving mechanism 36.

The detector coil 40 is a coil for detecting the position of the power receiving unit 22 of the terminal device 20 on the placement surface 12A. The position of the power receiving unit 22 of the terminal device 20 is represented by a position in the two-dimensional plane formed of the XY plane along the placement surface 12A. In a case where the power receiving unit 22 is an annular induction coil as illustrated in FIG. 1, the position of the power receiving unit 22 is defined as, for example, the position of a center point of an annular ring on the XY plane along the placement surface 12A. The detector coils 40 are plurally arranged along the placement surface 12A inside the placement surface 12A.

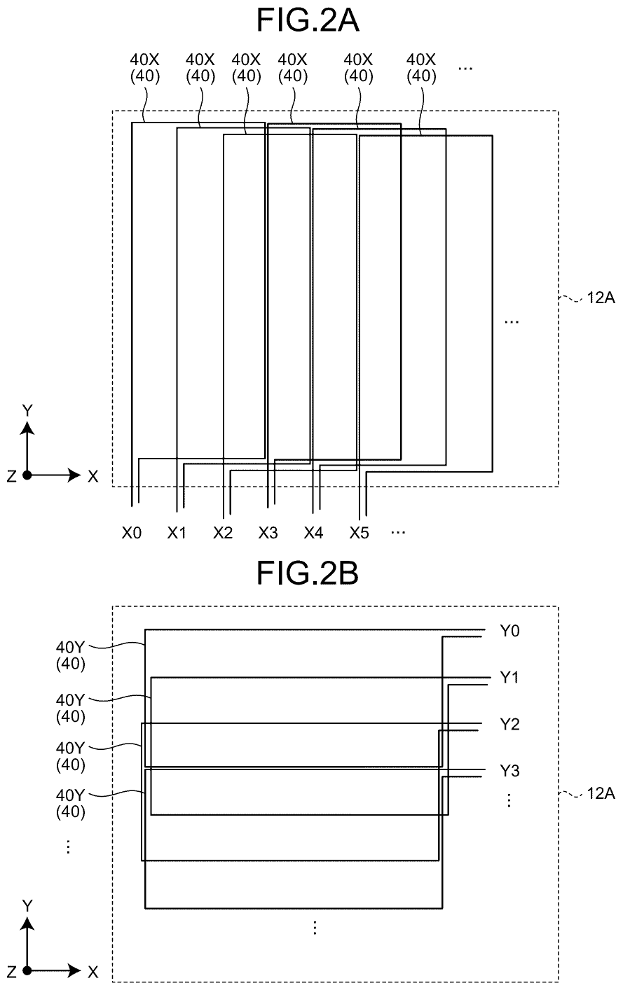

FIGS. 2A and 2B are schematic diagrams of an example of the arrangement of the detector coils 40.

As illustrated in FIGS. 2A and 2B, in the charging device 10, the plural detector coils 40 are arranged in a matrix in a direction intersecting each other.

Specifically, as illustrated in FIG. 2A, the charging device 10 includes detector coils 40X extending in the Y-axis direction on the two-dimensional plane along the placement surface 12A and arranged along the X-axis direction intersecting the Y-axis direction. FIG. 2A illustrates an example in which the detector coils 40X are arranged at the respective positions of positions X0 to Xn (n is an integer of 1 or more) in the X-axis direction along the placement surface 12A. The detector coils 40X are arranged such that some regions in the arrangement direction (X-axis direction) overlap with each other.

As illustrated in FIG. 2B, the charging device 10 includes detector coils 40Y extending in the X-axis direction on the two-dimensional plane along the placement surface 12A and arrayed along the Y-axis direction intersecting the X-axis direction. FIG. 2B illustrates an example in which the detector coils 40Y are arranged at the respective positions Y0 to Yn (n is an integer of 1 or more) in the Y-axis direction along the placement surface 12A. The detector coils 40Y are arranged such that some regions in the arrangement direction (Y-axis direction) overlap with each other.

In FIGS. 2A and 2B, the detector coils 40X and the detector coils 40Y are illustrated by using different drawings for the sake of description. However, in practice, in the charging device 10, the detector coils 40X and the detector coils 40Y are arranged to overlap with each other in the Z-axis direction. In FIGS. 2A and 2B, the detector coils 40 are illustrated as coils in one loop. However, each of the detector coils 40 may be a coil including two or more loops. The number of windings of the coils of the detector coils 40 may be adjusted in advance in accordance with on the target detection sensitivity.

In the following description, for the sake of description, processing related to position specification may be described by using the detector coils 40X arranged in the X-axis direction. However, in the charging device 10, it is needless to say that the processing related to the position specification is executed by using the detector coils 40X and the detector coils 40Y respectively arranged in the X-axis direction and the Y-axis direction.

Referring back to FIG. 1, the description will be continued.

The controller 50 executes information processing in the charging device 10.

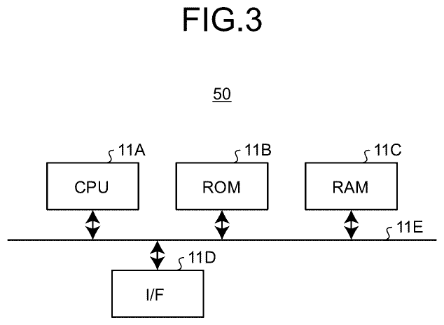

FIG. 3 is a hardware configuration diagram of an example of the controller 50.

In the controller 50, a central processing unit (CPU) 11A, a read only memory (ROM) 11B, a RAM 11C, an I/F 11D, and the like are mutually connected to each other by a bus 11E, and a hardware configuration using a normal computer is adopted.

The CPU 11A is an arithmetic device that controls the charging device 10 of the present embodiment. The ROM 11B stores programs and the like for implementing various types of processing by the CPU 11A. The RAM 11C stores data necessary for various types of processing by the CPU 11A. The I/F 11D is an interface for transmitting and receiving data.

A program for executing information processing executed by the charging device 10 of the present embodiment is provided by being incorporated in the ROM 11B or the like in advance. Note that the program executed by the charging device 10 of the present embodiment may be configured to be provided by being recorded in a computer-readable recording medium such as a CD-ROM, a flexible disk (FD), a CD-R, or a digital versatile disk (DVD) as a file in a format that can be installed or executed in the charging device 10.

For example, a part or all of the controller 50 may be implemented by causing a processing device such as the CPU 11A to execute a program, namely, by software, may be implemented by hardware such as an integrated circuit (IC), or may be implemented by using software and hardware in combination.

Referring back to FIG. 1, the description will be continued.

The controller 50 controls the power transmitter coil 30, the detector coils 40, and the moving mechanism 36. The controller 50 selectively and sequentially outputs transmitted signals for generating a magnetic field for detection to each of the detector coils 40. The controller 50 specifies the position of the power receiving unit 22 based on received signals that are responded from the power receiving unit 22 in reaction to the magnetic field for detection and are detected by the detector coils 40.

The specification of the position of the power receiving unit 22 by the controller 50 will be described.

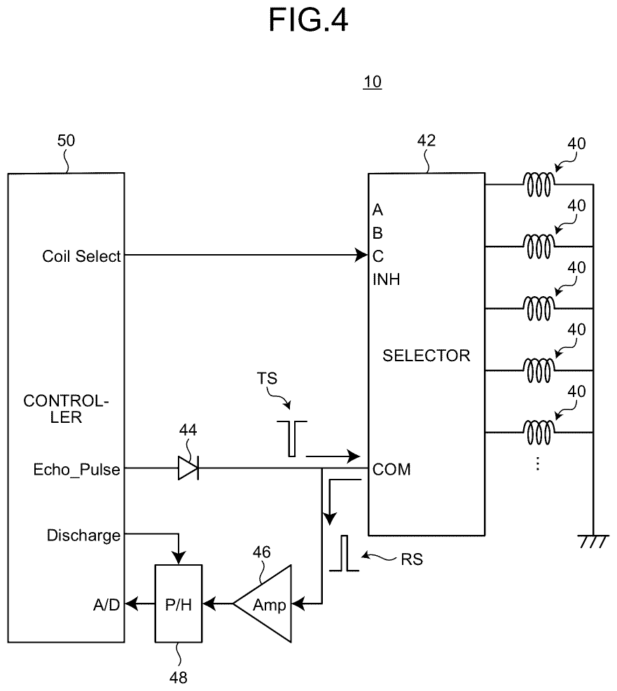

FIG. 4 is a schematic diagram of an example of a circuit configuration of the charging device 10. FIG. 4 illustrates a circuit configuration portion related to the position specification of the power receiving unit 22 in the charging device 10.

The charging device 10 includes the controller 50, the detector coils 40, a selector 42, a diode 44, an amplifier 46, and a P/H 48.

The controller 50 selectively outputs a transmitted signal TS to the predetermined detector coil 40 from an Echo_Pulse terminal via the diode 44 by switching the connection of the selector 42 via a Coil Select terminal.

The transmitted signal TS is a signal for generating a magnetic field for detection from the detector coil 40. The transmitted signal TS is, for example, a pulse signal. The pulse width of the pulse signal is, for example, about 500 ns. When the transmitted signal TS is input, the detector coil 40 generates a magnetic field for detection.

The controller 50 detects, via the selector 42, a received signal RS that is responded to the detector coil 40 from the power receiving unit 22 of the terminal device 20 in reaction to the magnetic field for detection generated in the detector coil 40 due to the transmitted signal TS being supplied.

The received signal RS is a signal that responds to the detector coil 40 from the power receiving unit 22. The received signal RS is a signal representing a change in the magnetic field due to counter electromotive force that responds, from the power receiving unit 22, to the detector coil 40 immediately after the output of the transmitted signal TS, and may be referred to as an echo signal.

The controller 50 selectively detects the received signal RS that responds to the predetermined detector coil 40 by switching the connection of the selector 42 via the Coil Select terminal. The received signal RS that responds to the detector coil 40 is held in the P/H 48 via the amplifier 46.

The P/H 48 is a Peak-Hold circuit. The received signal RS, which is an echo signal, is a signal of about 1 MHz. Therefore, the controller 50 cannot measure the instantaneous voltage of the received signal RS by low-speed A/D conversion. Therefore, the P/H 48 needs to hold the Peak voltage of the received signal RS. In order to reset the previous measurement value, the controller 50 outputs Discharge, which is a signal for discharging the charge stored in the P/H 48 to GND (ground), to the P/H 48 immediately before measurement of the next received signal RS. Then, the controller 50 performs A/D conversion on the received signal RS that is responded to the detector coil 40 and held in the P/H 48, thereby measuring the level of the A/D-converted received signal RS. In other words, the controller 50 acquires the level of the received signal RS that is responded to the detector coil 40 from the power receiving unit 22 in reaction to the magnetic field caused by the transmitted signal TS output to the detector coil 40.

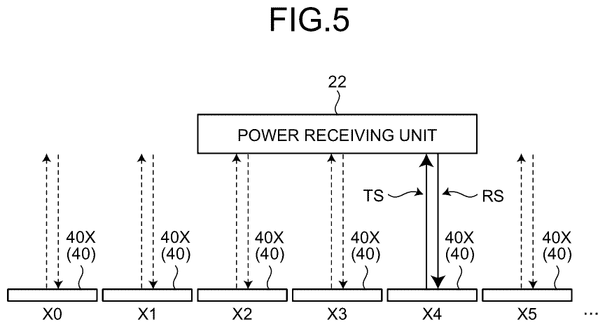

FIG. 5 is a schematic diagram illustrating an example of a basic concept of the position specification of the power receiving unit 22 by the controller 50. FIG. 5 illustrates the detector coils 40X arranged in the X-axis direction as an example. Note that the same applies to the detector coils 40Y arranged in the Y-axis direction.

The controller 50 selectively and sequentially outputs each of the transmitted signals TS in a time division manner to a corresponding one of the detector coils 40 arranged at positions respectively different from the positions X0, X1, X2, . . . by switching the connection of the selector 42. A magnetic field for detection is generated from the detector coil 40X by the transmitted signal TS, and the received signal RS is generated from the power receiving unit 22 as a response to the magnetic field. Then, the controller 50 measures the level of the received signal RS detected by the detector coil 40 serving as an output source of the transmitted signal TS.

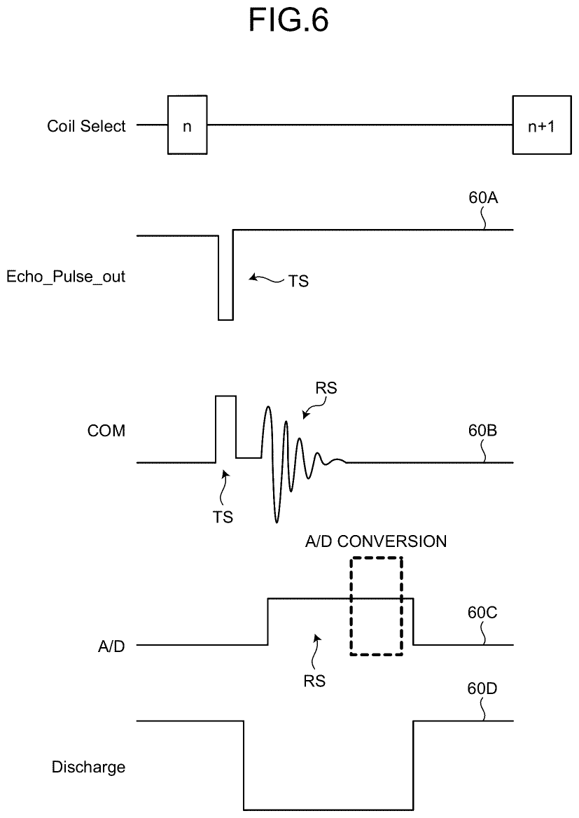

FIG. 6 is a schematic diagram illustrating an example of a timing chart related to measurement of the level of the received signal RS. FIG. 6 illustrates an example of a timing chart when the transmitted signal TS is output to the detector coil 40 and the level of the received signal RS detected by the detector coil 40 serving as the output source of the transmitted signal TS is measured as a response to the magnetic field generated by the transmitted signal TS.

For example, the controller 50 switches the connection of the selector 42 via the Coil Select terminal to bring the detector coil 40 located at a position of n and the controller 50 into a communicably connected state. Then, the controller 50 outputs the transmitted signal TS to the detector coil 40 located at the position of n (refer to a signal waveform 60A), and a COM terminal of the selector 42 outputs the transmitted signal TS and the received signal RS detected by the detector coil 40 located at the position of n to the controller 50 as a response to the transmitted signal TS (refer to a signal waveform 60B). The controller 50 outputs Discharge to the P/H 48 at a timing of outputting the transmitted signal TS to reset an immediately preceding measurement value (refer to a signal waveform 60D). The controller 50 performs A/D conversion on the received signal RS that has responded to the detector coil 40 located at the position of n and has been held in the P/H 48, thereby measuring the level of the received signal RS after the A/D conversion (refer to a signal waveform 60C).

That is, the controller 50 outputs the transmitted signal TS to one of the detector coils 40. When the transmitted signal TS is input, a current flows through the detector coil 40, and magnetic force is generated by the current. When the lines of magnetic force generated by the generated magnetic force pass through the power receiving unit 22 of the terminal device 20, a current flows through the power receiving unit 22 by counter electromotive force. Then, magnetic force is generated by the current flowing through the power receiving unit 22, and the magnetic line passes through the detector coil 40. Therefore, electromotive force is generated in the detector coil 40, and the electromotive force is amplified by the amplifier 46, converted into a constant voltage via the P/H 48, and read by the A/D of the controller 50. Through these operations, the controller 50 stores the level of the received signal RS that has responded to the detector coil 40. Then, the controller 50 sequentially performs the series of operations on each of the detector coils 40 provided in the charging device 10, and repeats the operation until it is detected that the terminal device 20 is placed on the placement surface 12A. For example, when any level of the received signal RS becomes equal to or higher than a certain voltage, the controller 50 determines that the terminal device 20 is placed on the placement surface 12A.

Then, upon determining that the terminal device 20 is placed on the placement surface 12A, the controller 50 specifies the position of the power receiving unit 22 of the terminal device 20 based on the level of the received signal RS received by each of the detector coils 40.

First, basic position specifying processing will be described.

For example, the controller 50 specifies the position of the power receiving unit 22 by using the position of the detector coil 40 that has detected the received signal RS of a maximum level, the maximum level, the position of the other detector coil 40 adjacent to the detector coil 40, and the level of the received signal RS detected by the other detector coil 40 adjacent to the detector coil 40.

Specifically, the controller 50 specifies the position of the power receiving unit 22 by using the position of the detector coil 40 that has detected the received signal RS at a maximum level, the position of the other detector coil 40 adjacent to the detector coil 40, and a ratio of the maximum level to the level of the received signal RS detected by the other detector coil 40 adjacent to the detector coil 40.

More specifically, the controller 50 defines, as X1st, the position of the detector coil 40X having a maximum level of the received signal RS among the detector coils 40X arranged in the X-axis direction, and defines the maximum level as List. In addition, the controller 50 defines, as X2nd, the position of one detector coil 40X having a higher level of the received signal RS among the detector coils 40X arranged on both sides in the X-axis direction with respect to the detector coil 40X having the maximum level of the received signal RS, and defines the level as L2nd. In addition, the controller 50 defines, as X3rd, the position of the other detector coil 40X having a low level of the received signal RS among the detector coils 40X arranged on both sides, and defines the level as L3rd.

Then, when L2nd=L3rd is satisfied, the controller 50 specifies X1st as a position P of the power receiving unit 22 of the terminal device 20. When L1st=L2nd is satisfied, the controller 50 specifies the position calculated by (X1st+X2nd)/2 as the position of the power receiving unit 22. When a relationship of L2nd=L3rd or L1st=L2nd is not satisfied, the controller 50 calculates the position of the power receiving unit 22 by a known interpolation formula using the ratio of L1st, L2nd, and L3rd.

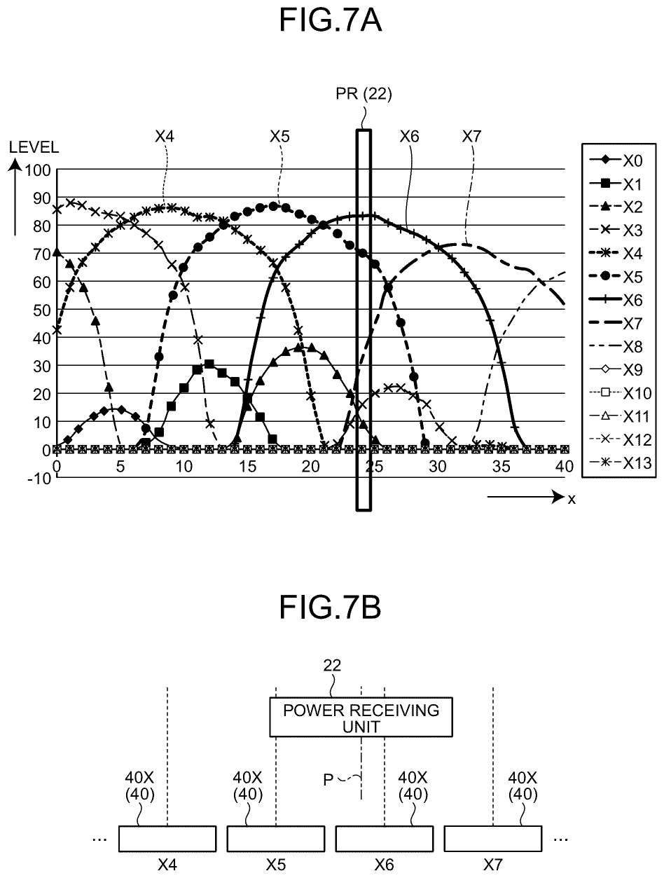

FIGS. 7A and 7B are explanatory diagrams of an example of specifying the position of the power receiving unit 22 by basic position specifying processing of the power receiving unit 22 based on the received signal RS.

FIG. 7A is a schematic diagram illustrating an example of a measurement result of the level of the received signal RS measured by each of the detector coils 40X arranged in the X-axis direction when the terminal device 20 placed on the placement surface 12A is moved in the X-axis direction by 1 mm and the terminal device 20 is present at each position. In FIG. 7A, the horizontal axis represents the position of the power receiving unit 22 of the terminal device 20, and the vertical axis represents the level of the measured received signal RS. In FIG. 7A, X0 to X13 represent the levels of the received signal RS detected by the detector coils 40X disposed at the positions X0 to X13, respectively.

Specifically, in FIG. 7A, a scene is assumed in which the terminal device 20 is placed at a position PR of 24 mm from the reference position in the X-axis direction. In this case, as illustrated in FIG. 7A, the level of the received signal RS detected by the detector coil 40X at a position X6 becomes the highest. In addition, the level of the received signal RS detected by the detector coil 40X at a position X5 is the second highest, and the level of the received signal RS detected by the detector coil 40X at a position X7 is the third highest.

In this case, the controller 50 specifies the position between the position X6 and the position X5 as the position P of the power receiving unit 22 based on the ratio of the levels of the received signals RS detected by these detector coils 40X (refer to FIG. 7B). Similarly, the controller 50 also specifies the position in the Y-axis direction, thereby specifying the position coordinate including each of the positions in the X-axis direction and the Y-axis direction of the power receiving unit 22 as the position P of the power receiving unit 22.

Here, the present inventors have found that it may be difficult to specify the position P of the power receiving unit 22 with high accuracy by a method of specifying the position of the power receiving unit 22 without considering a relative distance.

Specifically, the inventors of the present invention have found that the level of the received signal RS detected by each of the detector coils 40 varies with the relative distance between the position of the power receiving unit 22 placed on the placement surface 12A and the position of the power transmitter coil 30. That is, the present inventors have found that, even in the case of the received signal RS detected by the same detector coil 40, there is a case in which a difference occurs in the level of the received signal RS in accordance with the relative distance between the power receiving unit 22 and the power transmitter coil 30 at the time of detecting the received signal RS. In addition, the present inventors have found that the magnetic body sheet 32 affects a difference in the level of the received signal RS due to the relative distance.

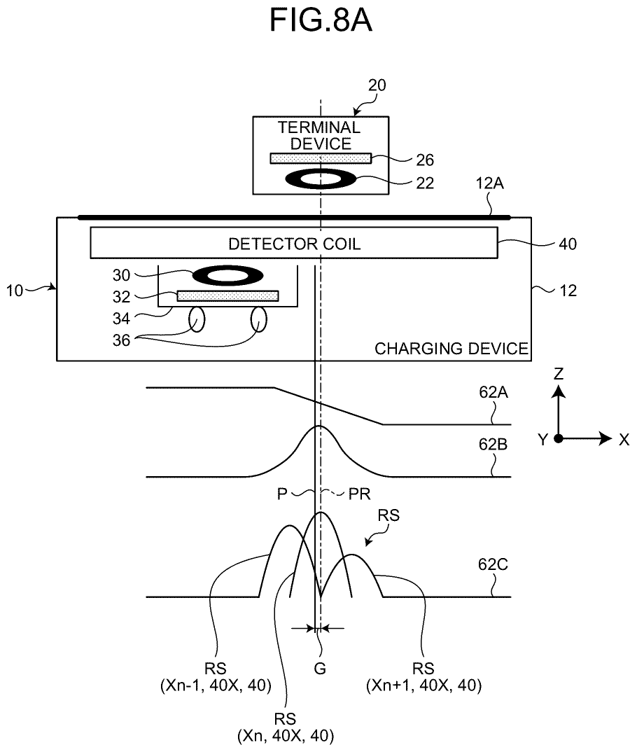

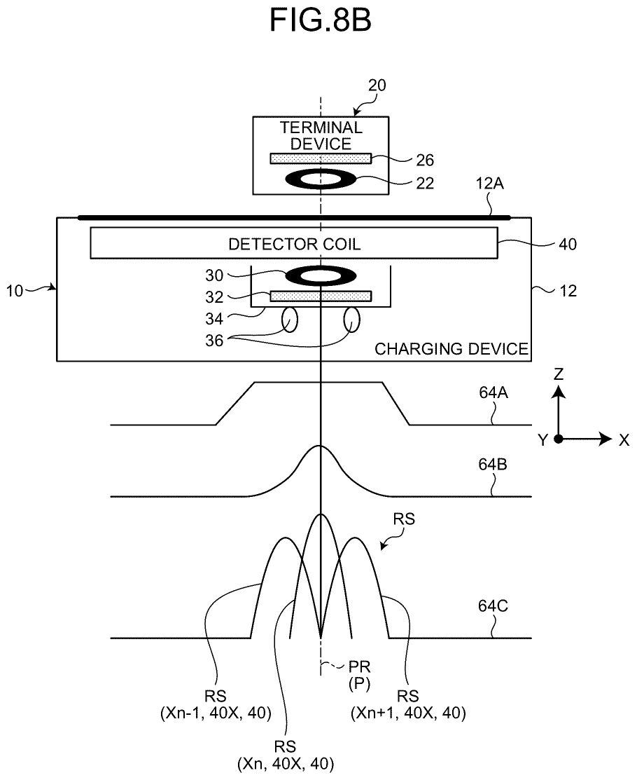

FIGS. 8A and 8B are explanatory diagrams of an example of a relationship between a relative distance between the power receiving unit 22 of the terminal device 20 and the power transmitter coil 30 and the level of received signal RS.

FIG. 8A is an explanatory diagram of an example of the level of the received signal RS in a case where the power receiving unit 22 and the power transmitter coil 30 are separated from each other, namely, in a case where the relative distance between them is large.

For example, in a case where the power receiving unit 22 and the power transmitter coil 30 are at positions separated from each other, the increase or decrease in the detection sensitivity of the received signal RS of the detector coil 40 by the magnetic body sheet 32 has a sensitivity gradient, for example, as illustrated in a line diagram 62A. Specifically, an L value of the detector coil 40 positioned on the magnetic body sheet 32 increases due to the influence of the magnetic body sheet 32 provided on the back surface side of the power transmitter coil 30, and the magnitude of the magnetic flux output from the detector coil 40 increases. Therefore, when the power receiving unit 22 and the power transmitter coil 30 are at positions separated from each other, the detection sensitivity of each of the received signals RS of the group of the detector coils 40 that detect each of the received signals RS at the maximum level and a level equivalent to the maximum level includes a sensitivity gradient corresponding to a relative distance, as illustrated in the line diagram 62A.

Further, the distribution of the sensitivity of the received signal RS is illustrated in a line diagram 62B. As illustrated in the line diagram 62B, the sensitivity of the received signal RS at the center position of the power receiving unit 22 of the terminal device 20 is maximized, and the sensitivity of the received signal RS decreases as a distance from the center position increases.

Then, as illustrated in a line diagram 62C, the level of the received signal RS detected by the detector coil 40X disposed at the position Xn corresponding to the center position of the power receiving unit 22 is maximized. In addition, the level of the received signal RS detected by the detector coil 40X arranged at each of the position Xn−1 and the position Xn+1 adjacent to Xn is a level lower than the maximum level.

As described above, when the power receiving unit 22 and the power transmitter coil 30 are at positions separated from each other, the detection sensitivity of each of the received signals RS of the group of the detector coils 40 that detect each of the received signals RS at the maximum level and a level equivalent to the maximum level includes a sensitivity gradient corresponding to the relative distance, as illustrated in the line diagram 62A. That is, when the power receiving unit 22 of the terminal device 20 is positioned at a position where the detection sensitivity of the received signal RS is inclined due to the influence of the magnetic body sheet 32, the level of the detected received signal RS changes.

In the example illustrated in FIG. 8A, the detector coil 40X disposed at each of the position Xn−1 and the position Xn+1 detects the received signal RS at substantially the same level as that when not affected by the magnetic body sheet 32. However, due to the influence of the magnetic body sheet 32, the detection sensitivity of the detector coil 40 at a position closer to the power transmitter coil 30 and the magnetic body sheet 32 is high, and the detection sensitivity of detector coil 40 at a position farther from the power transmitter coil 30 and the magnetic body sheet 32 is low. Therefore, the level of the received signal RS detected by the detector coil 40X disposed at the position Xn+1 farther from the magnetic body sheet 32 is lower than the level of the received signal RS detected by the detector coil 40X disposed at the position Xn−1 closer to the magnetic body sheet 32 among the detector coils 40X disposed at the respective positions Xn−1 and Xn+1.

Therefore, when the position of the power receiving unit 22 is specified by using the levels of these received signals RS without considering the relative distance, a gap G occurs between a specified position P and an actual position PR of the power receiving unit 22. That is, when the power receiving unit 22 of the terminal device 20 is positioned at a position where the detection sensitivity of the received signal RS is inclined due to the influence of the magnetic body sheet 32, the accuracy of specifying the position P of the power receiving unit 22 may deteriorate.

FIG. 8B is an explanatory diagram of an example of the level of the received signal RS in a case where the power receiving unit 22 and the power transmitter coil 30 are at substantially the same position, namely, in a case where the relative distance is small. The substantially same position means that the positions on the two-dimensional plane along the placement surface 12A are substantially the same.

For example, when the power receiving unit 22 and the power transmitter coil 30 are located at substantially the same position, the increase or decrease in the detection sensitivity of the received signal RS of the detector coil 40 by the magnetic body sheet 32 is, for example, as illustrated in a line diagram 64A. That is, when the power receiving unit 22 and the power transmitter coil 30 are located at substantially the same position, detection sensitivities of the respective received signals RS of the group of the detector coils 40 that detect the respective received signals RS at the maximum level and a level equivalent to the maximum level are substantially the same, namely, are in a flat state, as illustrated in the line diagram 64A.

Further, the distribution of the sensitivity of the received signal RS is illustrated in a line diagram 64B. As illustrated in the line diagram 64B, the sensitivity of the received signal RS at the center position of the power receiving unit 22 of the terminal device 20 is maximized, and the sensitivity of the received signal RS decreases as a distance from the center position increases.

Then, as illustrated in a line diagram 64C, the level of the received signal RS detected by the detector coil 40X disposed at the position Xn corresponding to the center position of the power receiving unit 22 is maximized. In addition, the level of the received signal RS detected by the detector coil 40X arranged at each of the position Xn−1 and the position Xn+1 adjacent to Xn is a level lower than the maximum level.

As described above, when the power receiving unit 22 and the power transmitter coil 30 are located at substantially the same position, detection sensitivities of the respective received signals RS of the group of the detector coils 40 that detect the respective received signals RS at the maximum level and a level equivalent to the maximum level are substantially the same, namely, are in a flat state, as illustrated in the line diagram 64A.

Therefore, when the power receiving unit 22 and the power transmitter coil 30 are located at substantially the same position, the influence of the magnetic body sheet 32 is suppressed, and the position of the power receiving unit 22 can be specified by using the received signal RS detected with high accuracy. Therefore, it is considered that the accuracy of specifying the position P of the power receiving unit 22 is improved.

Therefore, in the charging device 10 of the present embodiment, the controller 50 specifies the position P of the power receiving unit 22 in accordance with a relative distance between the first position of the power receiving unit 22, which is the position specified based on the received signal RS, and the power transmitter coil 30.

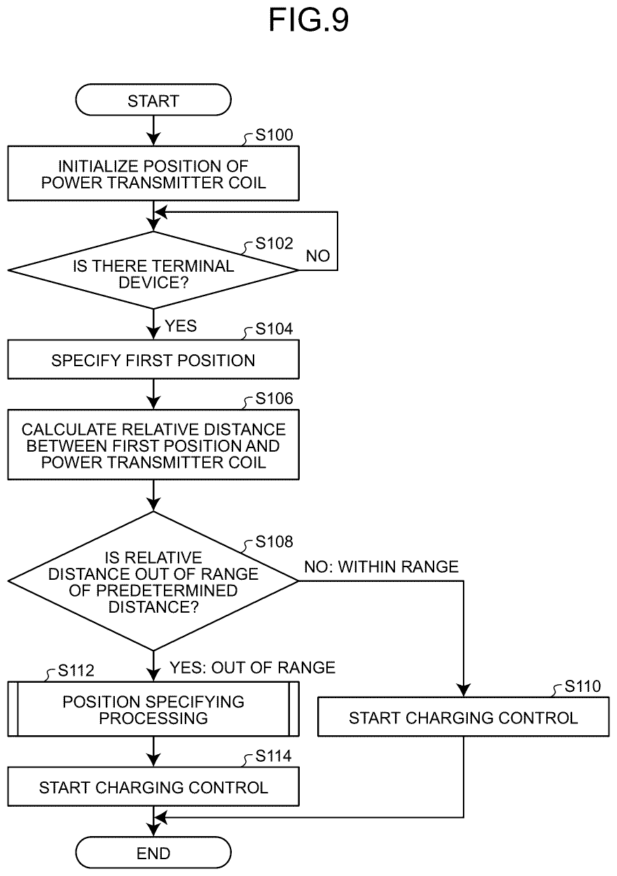

FIG. 9 is a flowchart illustrating an example of a procedure of information processing executed by the controller 50 according to the present embodiment.

The controller 50 initializes the position of the power transmitter coil 30 (step S100). The controller 50 controls the moving mechanism 36 to move the power transmitter coil 30 held on the conveyance table 34 on which the moving mechanism 36 is provided to a predetermined initial position on the placement surface 12A. The initial position is, for example, a position corresponding to the origin in each of the X-axis direction and the Y-axis direction of the placement surface 12A, which is a two-dimensional plane. With this movement control, the controller 50 initializes the position of the power transmitter coil 30.

Next, the controller 50 determines whether the terminal device 20 is placed on the placement surface 12A (step S102). When the terminal device 20 is placed on the placement surface 12A, a magnetic field is generated due to resonance caused by an impulse response. Therefore, the controller 50 makes a determination in step S102 by measuring the generated magnetic field. For example, the controller 50 makes a determination in step S102 by determining whether the level of the received signal RS detected by at least one of the detector coils 40 varies by a threshold or more. The controller 50 repeats a negative determination (step S102: No) until an affirmative determination is made in step S102 (step S102: Yes). When the controller 50 makes an affirmative determination in step S102 (step S102: Yes), the processing proceeds to step S104.

In step S104, the controller 50 specifies a first position P1 of the power receiving unit 22 (step S104).

The first position P1 means a position P of the power receiving unit 22 specified based on the received signal RS that is detected in response to the transmitted signal TS output in a state where the power transmitter coil 30 exists at the initial position.

For example, the controller 50 selectively and sequentially outputs the transmitted signal TS to each of the detector coils 40. Then, the controller 50 detects the levels of the received signals RS that are respectively responded from the power receiving unit 22 in reaction to the magnetic field for detection and are detected by the detector coils 40 each serving as the output source of the transmitted signal TS. Then, based on the level of the received signal RS detected by each of the detector coils 40, the controller 50 specifies the position P of the power receiving unit 22 by the basic position specifying processing using the above-described ratio, thereby specifying the position P as the first position P1.

Next, the controller 50 calculates a relative distance between the first position P1 specified in step S104 and the position of the power transmitter coil 30 (step S106). For example, the controller 50 stores in advance initial position information indicating an initial position at which the movement of the power transmitter coil 30 is controlled in step S100. Then, the controller 50 calculates the relative distance by calculating a distance between the first position P1 specified in step S104 and the initial position indicated by the initial position information.

Next, the controller 50 determines whether the relative distance calculated in step S106 is out of the range of a predetermined distance.

The range of the predetermined distance may be determined in advance. For example, for the range of the predetermined distance, a range in which the power receiving unit 22 and the power transmitter coil 30 are determined to be located at substantially the same position in the two-dimensional plane along the placement surface 12A may be set in advance. In addition, the range of the predetermined distance may be set in advance to a range of the relative distance in which the increase or decrease in the detection sensitivity of the received signal RS of the detector coil 40 due to the influence of the magnetic body sheet 32 described with reference to the line diagram 62A of FIG. 8A and the line diagram 64A of FIG. 8B becomes substantially the same, namely, a flat state at the respective positions of the group of the detector coils 40 that detect the respective received signals RS at the maximum and the level equivalent to the maximum.

When the relative distance calculated in step S106 is within the range of the predetermined distance (step S108: No), the controller 50 starts charging control from the power transmitter coil 30 to the power receiving unit 22 (step S110).

Specifically, the controller 50 applies AC power to the power transmitter coil 30, communicates with the terminal device 20 via the power transmitter coil 30, and controls power to be supplied in response to a power request command from the terminal device 20. The controller 50 includes a circuit for performing bidirectional communication with the terminal device 20, and communicates with the terminal device 20 through the circuit. The power transmitter coil 30 is electromagnetically coupled to the power receiving unit 22 of the terminal device 20 so as to supply the AC power to the power receiving unit 22. The AC power supplied to the power receiving unit 22 is converted into DC power by a rectifier provided in the terminal device 20 so as to charge the battery 24. Therefore, the battery 24 of the terminal device 20 is wirelessly charged. Then, this routine is ended.

On the other hand, when the relative distance calculated in step S106 is out of the range of the predetermined distance (step S108: Yes), the controller 50 proceeds to step S112.

In step S112, the controller 50 executes unique position specifying processing to specify the position of the power receiving unit 22 of the terminal device 20 (step S112). Then, the controller 50 starts charging control in the same manner as in step S110 (step S114), and ends this routine.

The unique position specifying processing in step S112 will be described in detail.

When the relative distance between the first position of the power receiving unit 22 and the power transmitter coil 30 is out of the range of the predetermined distance, the controller 50 executes any one of first position specifying processing, second position specifying processing, third position specifying processing, and fourth position specifying processing.

### (First Position Specifying Processing)

First, the first position specifying processing will be described.

The controller 50 executes the following processing as the first position specifying processing. Specifically, when the relative distance is out of the range of the predetermined distance, the controller 50 controls movement of the power transmitter coil 30 to the first position P1. Then, the controller 50 specifies a second position P2, which is the position of the power receiving unit 22 specified based on the received signal RS that has been detected in response to the transmitted signal TS output in a state where the power transmitter coil 30 is present at the first position P1, as the position P of the power receiving unit 22.

The second position P2 means the position P of the power receiving unit 22 specified based on the received signal RS detected in response to the transmitted signal TS output in a state where the power transmitter coil 30 is present at the first position P1.

That is, in the first position specifying processing, the power transmitter coil 30 is controlled to move to the first position P1 temporarily specified as the position P of the power receiving unit 22, and the second position P2 specified based on the received signal RS detected in response to the transmitted signal TS output in a state where the power transmitter coil 30 is present at the first position P1 is specified as the formal position P of the power receiving unit 22.

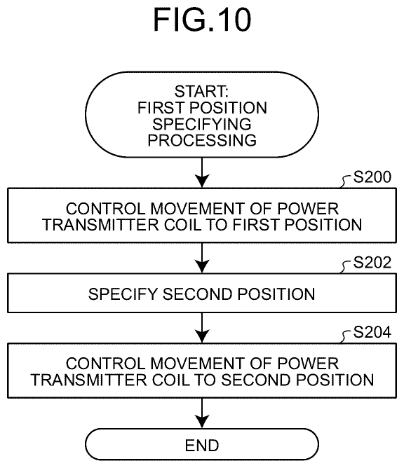

FIG. 10 is a flowchart illustrating an example of a procedure of the first position specifying processing executed by the controller 50.

The controller 50 controls the movement of the power transmitter coil 30 to the first position P1 specified in step S104 (refer to FIG. 9) (step S200). Specifically, the controller 50 controls the moving mechanism 36 to move to the first position P1. When the moving mechanism 36 moves the conveyance table 34 to the first position P1 under the control of the controller 50, the power transmitter coil 30 placed on the conveyance table 34 moves to the first position P1.

Next, the controller 50 specifies the second position P2 of the power receiving unit 22 (step S202). For example, the controller 50 selectively and sequentially outputs the transmitted signal TS to each of the detector coils 40. Then, the controller 50 detects the levels of the received signals RS that are respectively responded from the power receiving unit 22 in reaction to the magnetic field for detection and are detected by the detector coils 40 each serving as the output source of the transmitted signal TS. Then, based on the level of the received signal RS detected by each of the detector coils 40, the controller 50 specifies the position P of the power receiving unit 22 by the basic position specifying processing using the above-described ratio, thereby specifying the second position P2.

The controller 50 then controls the movement of the power transmitter coil 30 to the second position P2 specified in step S202 (step S204). Specifically, the controller 50 controls the moving mechanism 36 to move to the second position P2. When the moving mechanism 36 moves the conveyance table 34 to the second position P2 under the control of the controller 50, the power transmitter coil 30 placed on the conveyance table 34 moves to the second position P2. Then, this routine is ended.

Therefore, the controller 50 executes the first position specifying processing illustrated in FIG. 10 as the position specifying processing in step S112 illustrated in FIG. 9, whereby charging control from the power transmitter coil 30 moved to the second position P2 to the power receiving unit 22 is started.

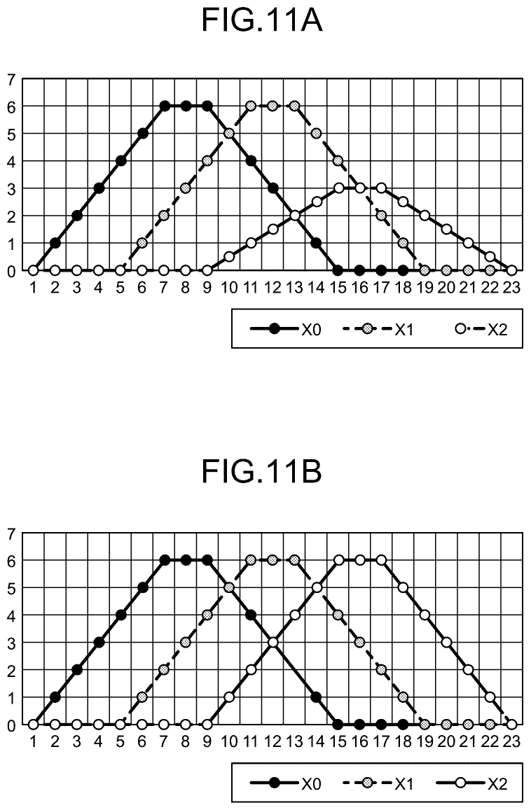

FIGS. 11A and 11B are explanatory diagrams of an example of an effect of the first position specifying processing.

In FIGS. 11A and 11B, the horizontal axis represents the position of the placement surface 12A in the X-axis direction. The vertical axis represents the level of the received signal RS. In FIGS. 11A and 11B, X0, X1, and X2 represent the levels of the received signals RS detected by the detector coils 40X disposed at positions X0, X1, and X2, respectively.

FIG. 11A is an explanatory diagram of the received signal RS detected by each of the detector coils 40 that have detected the received signal RS used for specifying the first position P1. In the state illustrated in FIG. 11A, a scene is assumed in which the power transmitter coil 30 is present at the position X0, and the power receiving unit 22 is disposed at a position of “14 mm” from the origin in the X-axis direction, which is an intermediate position between the position X1 and the position X2.

For example, in a state where the relative distance between the power transmitter coil 30 and the power receiving unit 22 is out of the range of the predetermined distance, the received signal RS detected by the detector coil 40X disposed at each of the positions X0, X1, and X2 is as illustrated in FIG. 11A. That is, as described above with reference to FIG. 8A, the received signal RS includes the sensitivity gradient due to the influence of the magnetic body sheet 32. Therefore, the first position P1 of the power receiving unit 22 specified by using the levels of these received signals RS is, for example, a position of “16 mm” from the origin, which is an intermediate position between the position X1 and the position X2, and deviation of 2 mm occurs with respect to the actual position.

FIG. 11B is an explanatory diagram of the received signal RS detected by each of the detector coils 40 that have detected the received signals RS used for specifying the second position P2. In the state illustrated in FIG. 11B, it is assumed that the power transmitter coil 30 is present at the first position P1, and the power receiving unit 22 is disposed at the position of “14 mm” from the origin in the X-axis direction, which is the intermediate position between the position X1 and the position X2 as in FIG. 11A.

The received signal RS detected by the detector coil 40X arranged at each of the positions X0, X1, and X2 in the state where the power transmitter coil 30 is present at the position of the first position P1 is as illustrated in FIG. 11B. That is, as described above with reference to FIG. 8B, the received signal RS does not include the sensitivity gradient due to the influence of the magnetic body sheet 32. Therefore, the second position P2 of the power receiving unit 22 specified by using the levels of these received signals RS is the position of “14 mm” from the origin, which is an intermediate position between the position X1 and the position X2, and the actual position “14 mm” is specified as the formal position P of the power receiving unit 22.

As described above, in the first position specifying processing, the controller 50 controls the movement of the power transmitter coil 30 to the first position P1 temporarily specified as the position P of the power receiving unit 22. Then, the controller 50 specifies the second position P2 specified based on the received signal RS detected in response to the transmitted signal TS output in a state where the power transmitter coil 30 is present at the first position P1 as the formal position P of the power receiving unit 22.

Since the second position P2 is specified based on the received signal RS detected in response to the transmitted signal TS output in a state where the power transmitter coil 30 is present at the first position P1, the controller 50 can specify the second position P2 in a state where the influence of the sensitivity gradient by the magnetic body sheet 32 is suppressed. Therefore, by executing the first position specifying processing, the controller 50 can specify the position P of the power receiving unit 22 of the terminal device 20 with higher accuracy as compared with a case in which the first position P1 is specified as the formal position P of the power receiving unit 22.

### (Second Position Specifying Processing)

Next, the second position specifying processing will be described.

The controller 50 executes the following processing as the second position specifying processing. Specifically, when the relative distance is out of the range of the predetermined distance, the controller 50 starts the charging control from the power transmitter coil 30 to the power receiving unit 22 after controlling the movement of the power transmitter coil 30 to the first position P1. Then, when the terminal device 20 that has started the charging control is a predetermined terminal device determined in advance, the controller 50 stops the charging control. Then, the controller 50 specifies, as the second position P2, the position P of the power receiving unit 22 specified based on the received signal RS detected in response to the transmitted signal TS output in a state where the power transmitter coil 30 is present at the first position P1. Then, the controller 50 specifies the specified second position P2 as the formal position P of the power receiving unit 22.

The predetermined terminal device may be the predetermined terminal device 20. For example, the predetermined terminal device is a magnet-mounted terminal device in which a magnet is disposed on at least part of the outer periphery of the power receiving unit 22. The terminal device with a magnet may be referred to as a magnetic power profile (MPP) terminal.

Further, the controller 50 starts the charging control of the power of a first frequency from the power transmitter coil 30 to the power receiving unit 22 after controlling the movement of the power transmitter coil 30 to the first position P1. Then, the controller 50 may start the charging control of the power having a second frequency higher than the first frequency from the power transmitter coil 30 to the power receiving unit 22 after controlling the movement of the power transmitter coil 30 to the second position P2. That is, when the terminal device 20 is a predetermined terminal device such as a terminal device with a magnet, the controller 50 may perform power reception control with the power of the first frequency in a state where the power transmitter coil 30 is located at the first position P1, and may perform rapid charging by the power of the second frequency higher than the first frequency in a state where the power transmitter coil 30 is located at the second position P2 which is a more accurate position.

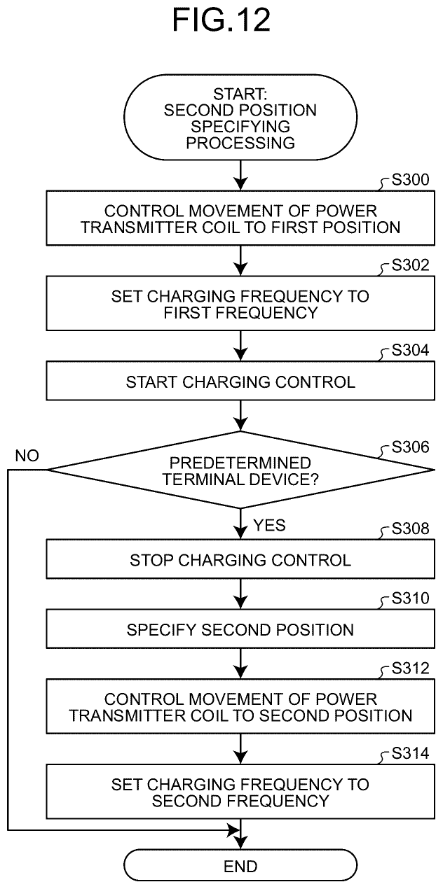

FIG. 12 is a flowchart illustrating an example of a procedure of the second position specifying processing executed by the controller 50.

The controller 50 controls the movement of the power transmitter coil 30 to the first position P1 specified in step S104 (refer to FIG. 9) (step S300). Specifically, the controller 50 controls the moving mechanism 36 to move to the first position P1. When the moving mechanism 36 moves the conveyance table 34 to the first position P1 under the control of the controller 50, the power transmitter coil 30 placed on the conveyance table 34 moves to the first position P1.

Next, the controller 50 sets a charging frequency to the first frequency (step S302). The first frequency is, for example, 128 kHz, but is not limited to this value. Then, the controller 50 applies the AC voltage of the first frequency set in step S302 to the power transmitter coil 30, and starts charging control from the power transmitter coil 30 to the power receiving unit 22 (step S304).

Next, the controller 50 determines whether the terminal device 20 including the power receiving unit 22 that has started charging in step S304 is a predetermined terminal device (step S306). The controller 50 communicates with the terminal device 20 via the power transmitter coil 30, and receives information indicating whether the terminal device 20 is a predetermined terminal device from the terminal device 20, thereby executing the determination in step S306.

Upon determining that the terminal device is not the predetermined terminal device (step S306: No), the controller 50 ends this routine. Therefore, in a case of negative determination in step S306, the controller 50 continues the charging control started in step S304. On the other hand, upon determining that the terminal device is the predetermined terminal device (step S306: Yes), the controller 50 proceeds to step S308.

In step S308, the controller 50 stops the charging control started in step S304 (step S308), and proceeds to step S310. Note that the controller 50 may communicate with the terminal device 20 via the power transmitter coil 30, and may further determine whether a signal indicating a charging frequency change instruction has been received from the terminal device 20. Then, when the signal indicating the charging frequency change instruction has not been received, the controller 50 may continue the charging control started in step S304 without stopping the charging control and may end this routine. On the other hand, upon receiving the signal indicating the charging frequency change instruction, the controller 50 may execute the processing in step S308.

In step S310, the controller 50 specifies the second position P2 of the power receiving unit 22 (step S310). The controller 50 then controls the movement of the power transmitter coil 30 to the second position P2 specified in step S310 (step S312). The processing in steps S310 and S312 is similar to the processing in steps S202 and S204 described above, respectively.

Then, the controller 50 sets the charging frequency to the second frequency (step S314). The second frequency may be higher than the first frequency. The second frequency is, for example, 360 kHz, but is not limited to this value. Then, this routine is ended.

When the controller 50 executes the second position specifying processing in FIG. 12 as the position specifying processing in step S112 in FIG. 9, rapid charging control at the second frequency is started from the power transmitter coil 30 moved to the second position P2 to the power receiving unit 22.

As described above, in the second position specifying processing, the movement of the power transmitter coil 30 is controlled to the first position P1 temporarily specified as the position P of the power receiving unit 22. Then, in the second position specifying processing, when the terminal device 20 is the predetermined terminal device, the second position P2 specified based on the received signal RS detected in response to the transmitted signal TS output in the state where the power transmitter coil 30 is present at the first position P1 is specified as the formal position P of the power receiving unit 22. In the second position specifying processing, the power transmitter coil 30 that is present at the first position P1 starts the charging control of the power of the first frequency, and when the terminal device 20 is the predetermined terminal device, the power transmitter coil 30 is moved to the second position P2, which is the more accurate position P, and the charging control of the power of the second frequency is further started.

In the second position specifying processing, the second position P2 is specified based on the received signal RS detected in response to the transmitted signal TS output in the state where the power transmitter coil 30 is present at the first position P1. Therefore, the controller 50 can specify the second position P2 in a state where the influence of a sensitivity variation due to the magnetic body sheet 32 is suppressed. That is, by executing the second position specifying processing, the controller 50 can specify the position of the power receiving unit 22 of the terminal device 20 with higher accuracy as compared with a case in which the first position P1 is specified as the formal position P of the power receiving unit 22.

In addition, by executing the second position specifying processing, the controller 50 can rapidly charge a predetermined terminal device after aligning the position of the power transmitter coil 30 with high accuracy.

### (Third Position Specifying Processing)

Next, the third position specifying processing will be described.

The controller 50 executes the following processing as the third position specifying processing. Specifically, when the relative distance is out of the range of the predetermined distance, the controller 50 specifies the position of the power receiving unit 22 based on a corrected received signal obtained by correcting the received signal RS used for specifying the first position P1 by a correction coefficient Ke corresponding to the relative distance.

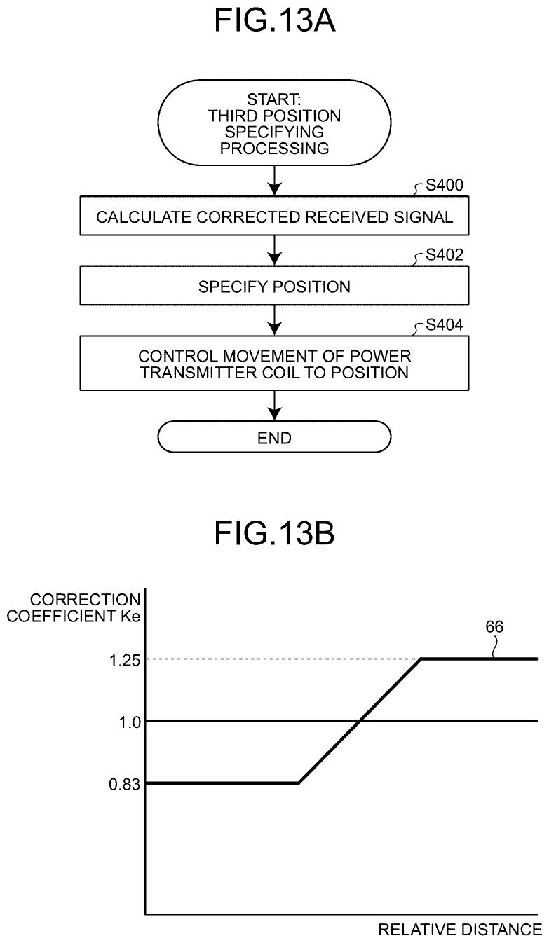

FIG. 13A is a flowchart illustrating an example of a procedure of third position specifying processing executed by the controller 50.

The controller 50 calculates a corrected received signal obtained by correcting the received signal RS used for specifying the first position P1 specified in step S104 (refer to FIG. 9) with the correction coefficient Ke corresponding to the relative distance between the first position P1 and the power transmitter coil 30 (step S400).

Specifically, the controller 50 acquires the level of the received signal RS used for specifying the first position P1 specified in step S104 (refer to FIG. 9). For example, the controller 50 acquires a level List, a level L2nd, and a level L3rd of the received signal RS as the levels of the received signals RS used for specifying the first position P1.

Next, the controller 50 specifies the correction coefficient Ke corresponding to the relative distance between the first position P1 and the power transmitter coil 30. The correction coefficient Ke is a coefficient for canceling the sensitivity gradient due to the magnetic body sheet 32 included in the received signal RS.

FIG. 13B is an explanatory diagram of the correction coefficient Ke. In FIG. 13B, the horizontal axis represents the relative distance, and the vertical axis represents the correction coefficient Ke. As illustrated in FIG. 13B, when the relative distance is short, namely, when the positions of the power receiving unit 22 and the power transmitter coil 30 are close to each other, the correction coefficient Ke represents a value smaller than 1. In addition, when the relative distance is long, namely, when the positions of the power receiving unit 22 and the power transmitter coil 30 are far from each other, the correction coefficient Ke represents a value larger than 1.

The controller 50 stores in advance a piece of relationship information or a function illustrated in FIG. 13B indicating a relationship of the correction coefficient Ke corresponding to the relative distance between the first position P1 and the power transmitter coil 30. Then, the controller 50 may specify the correction coefficient Ke corresponding to the relative distance between the first position P1 and the power transmitter coil 30 from the relationship information or the function.

Next, the controller 50 multiplies each of the level L1st, the level L2nd, and the level L3rd of each of the received signals RS used for specifying the first position P1 by the specified correction coefficient Ke. The controller 50 calculates each of a corrected level L1st′, a level L2nd′, and a level L3rd′, which are the multiplication processing results, as a corrected received signal of each of the received signals RS.

As described above, the correction coefficient Ke is a coefficient for canceling the sensitivity gradient due to the magnetic body sheet 32 included in the received signal RS. Therefore, the corrected level L1st′, level L2nd′, and level L3rd′, which are the corrected received signals, are levels in which the influence of the sensitivity gradient by the magnetic body sheet 32 is canceled out.

Referring back to FIG. 13A, the description will be continued. Next, the controller 50 specifies the position P of the power receiving unit 22 by using the corrected received signal calculated in step S400 (step S402). That is, the controller 50 re-specifies the position P of the power receiving unit 22 by using the corrected received signal obtained by correcting the received signal RS used for specifying the first position P1. The controller 50 may specify the position P of the power receiving unit 22 by performing processing similar to the processing of specifying the first position P1 in step S104 except that the corrected level L1st′, level L2nd′, and level L3rd′ are used instead of each of the level L1st, level L2nd, and level L3rd.

Then, the controller 50 performs control the movement of the power transmitter coil 30 to the position P specified in step S402 (step S404). Specifically, the controller 50 controls the moving mechanism 36 to move to the position P specified in step S402. When the moving mechanism 36 moves the conveyance table 34 to the position P under the control of the controller 50, the power transmitter coil 30 placed on the conveyance table 34 moves to the position P. Then, this routine is ended.

Therefore, the controller 50 executes the third position specifying processing illustrated in FIG. 13A as the position specifying processing in step S112 illustrated in FIG. 9, whereby the charging control from the power transmitter coil 30 moved to the position P specified with high accuracy to the power receiving unit 22 is started.

As described above, in the third position specifying processing, the controller 50 specifies the position P of the power receiving unit 22 based on the corrected received signal obtained by correcting the received signal RS used for specifying the first position P1 temporarily specified as the position P of the power receiving unit 22 by the correction coefficient Ke corresponding to the relative distance. Then, the controller 50 specifies the position P of the power receiving unit 22 specified based on the corrected received signal as the formal position P of the power receiving unit 22.

That is, the controller 50 specifies the position P of the power receiving unit 22 by using the corrected received signal in which the influence of the sensitivity gradient by the magnetic body sheet 32 is canceled out. Therefore, the controller 50 can specify the position of the power receiving unit 22 of the terminal device 20 with high accuracy.

### (Fourth Position Specifying Processing)

Next, the fourth position specifying processing will be described.

The controller 50 executes the following processing as the fourth position specifying processing. Specifically, when the relative distance is out of the range of the predetermined distance, the controller 50 specifies the position P of the power receiving unit 22 based on a third position P3 and a fourth position P4.

The third position P3 is a position P specified based on a first received signal RS1, which is the received signal RS detected by each of the detector coils 40 each serving as the output source of the transmitted signal TS, in response to the transmitted signal TS sequentially output to each of the detector coils 40. The first received signal RS1 is an example of the received signal RS.

The fourth position P4 is a position P specified based on a second received signal RS2, which is the received signal RS detected by each of the other detector coils 40 other than the output source of the transmitted signal TS, in response to the transmitted signal TS sequentially output to each of the detector coils 40. The second received signal RS2 is an example of the received signal RS.

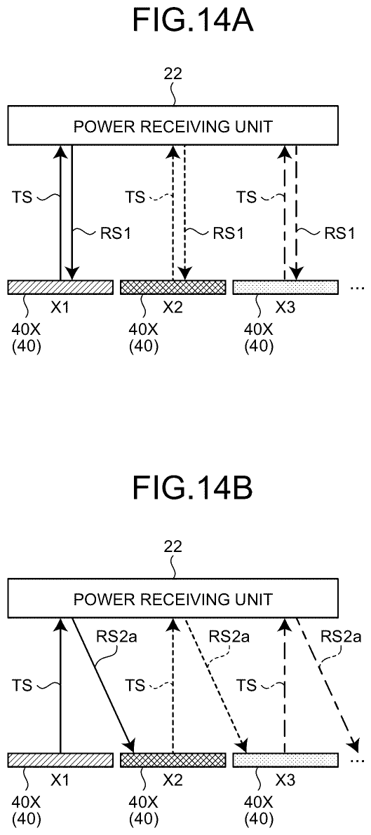

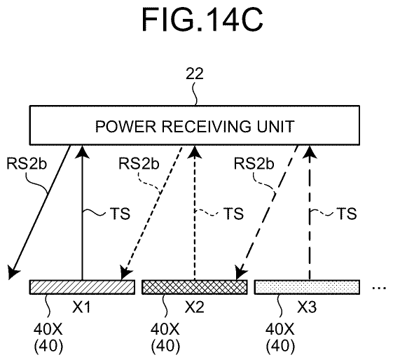

FIGS. 14A to 14C are explanatory diagrams of an example of the fourth position specifying processing.

As illustrated in FIG. 14A, the controller 50 selectively and sequentially outputs the transmitted signal TS to each of the detector coils 40 disposed at positions respectively different from the positions X1, X2, X3, . . . in a time division manner. Then, the controller 50 measures the level of the first received signal RS1, which is the received signal RS detected by the detector coil 40 serving as the output source of the transmitted signal TS. Then, the controller 50 specifies the position P of the power receiving unit 22 by the basic position specifying processing using the above-described ratio based on the first received signal RS1, thereby specifying the third position P3 of the power receiving unit 22.

As illustrated in FIG. 14B, the controller 50 selectively and sequentially outputs the transmitted signal TS to each of the detector coils 40 disposed at positions respectively different from the positions X1, X2, X3, . . . in a time division manner. Then, the controller 50 measures the level of a second received signal RS2a, which is the received signal RS detected by the other detector coil 40 other than the output source of the transmitted signal TS. The second received signal RS2a is an example of the second received signal RS2. FIG. 14B illustrates, as the second received signal RS2a, the second received signal RS2a detected by the next detector coil 40 adjacent to the detector coil 40 serving as the output source of the transmitted signal TS. Then, the controller 50 specifies the position P of the power receiving unit 22 by the basic position specifying processing using the above-described ratio based on the second received signal RS2a, thereby specifying a fourth position P4a of the power receiving unit 22. The fourth position P4a is an example of the fourth position P4.

As illustrated in FIG. 14C, the controller 50 selectively and sequentially outputs the transmitted signal TS to each of the detector coils 40 disposed at positions respectively different from the positions X1, X2, X3, . . . in a time division manner. Then, the controller 50 measures the level of a second received signal RS2b, which is the received signal RS detected by the other detector coil 40 other than the output source of the transmitted signal TS. The second received signal RS2b is an example of the second received signal RS2. FIG. 14C illustrates, as the second received signal RS2b, the second received signal RS2b detected by the previous detector coil 40 adjacent to the detector coil 40 serving as the output source of the transmitted signal TS. Then, the controller 50 specifies the position P of the power receiving unit 22 by the basic position specifying processing using the above-described ratio based on the second received signal RS2b, thereby specifying a fourth position P4b of the power receiving unit 22. The fourth position P4b is an example of the fourth position P4.

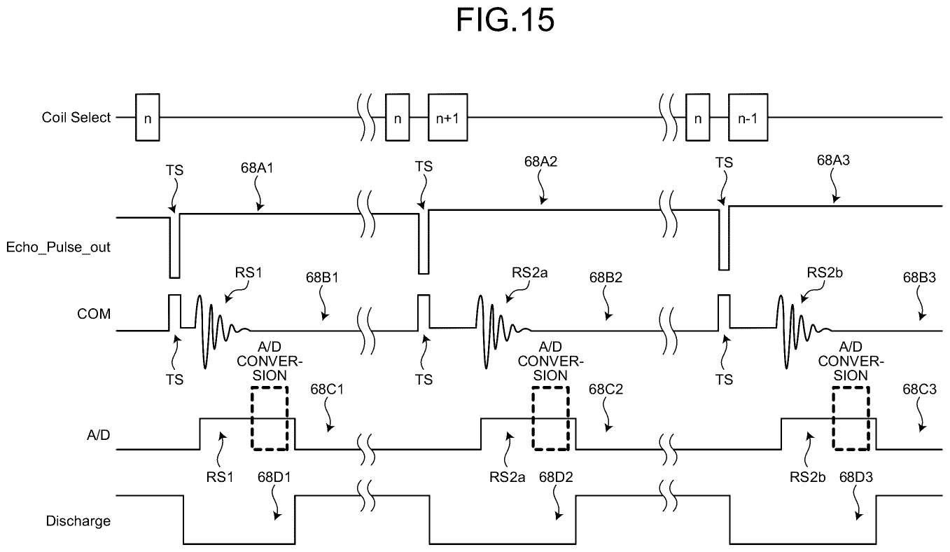

FIG. 15 is a schematic diagram illustrating an example of a timing chart related to the measurement of the level of the second received signal RS2. FIG. 15 illustrates an example of a timing chart when the transmitted signal TS is output to the detector coil 40 and the level of each of the first received signal RS1, the second received signal RS2a, and the second received signal RS2b is measured.

For example, the controller 50 switches the connection of the selector 42 via the Coil Select terminal to bring the detector coil 40 located at a position of n and the controller 50 into a communicably connected state. Then, the controller 50 outputs the transmitted signal TS to the detector coil 40 located at the position of n (refer to a signal waveform 68A1), and the COM terminal of the selector 42 outputs the transmitted signal TS and the received signal RS detected by the detector coil 40 located at the position of n to the controller 50 as a response to the transmitted signal TS (refer to a signal waveform 68B1). The controller 50 outputs Discharge to the P/H 48 at a timing of outputting the transmitted signal TS to reset an immediately preceding measurement value (refer to a signal waveform 68D1). The controller 50 performs A/D conversion on the received signal RS that has responded to the detector coil 40 located at the position of n and has been held in the P/H 48, thereby measuring the level of the first received signal RS1 after the A/D conversion (refer to a signal waveform 68C1).

Further, the controller 50 switches the connection of the selector 42 via the Coil Select terminal to bring the detector coil 40 located at a position of n and the controller 50 into a communicably connected state. Then, after the controller 50 outputs the transmitted signal TS to the detector coil 40 located at the position of n (refer to a signal waveform 68A2), the connection of the selector 42 is switched via the Coil Select terminal to bring the detector coil 40 located at a position of n+1 and the controller 50 into a communicably connected state.

The COM terminal of the selector 42 outputs the transmitted signal TS detected by the detector coil 40 located at the position of n+1 and the second received signal RS2a of the detector coil 40 located at the position of n+1 to the controller 50 as a response to the transmitted signal TS (refer to a signal waveform 68B2). The controller 50 outputs the Discharge to the P/H 48 at a timing of outputting the transmitted signal TS to reset an immediately preceding measurement value (refer to a signal waveform 68D2). The controller 50 performs A/D conversion on the second received signal RS2a that has responded to the detector coil 40 located at the position of n+1 and has been held in the P/H 48, thereby measuring the level of the second received signal RS2a after the A/D conversion (refer to a signal waveform 68C2).

Further, the controller 50 switches the connection of the selector 42 via the Coil Select terminal to bring the detector coil 40 located at a position of n and the controller 50 into a communicably connected state. Then, after the controller 50 outputs the transmitted signal TS to the detector coil 40 located at the position of n (refer to a signal waveform 68A3), the connection of the selector 42 is switched via the Coil Select terminal to bring the detector coil 40 located at a position of n−1 and the controller 50 into a communicably connected state.

The COM terminal of the selector 42 outputs the transmitted signal TS detected by the detector coil 40 located at the position of n−1 and the second received signal RS2b of the detector coil 40 located at the position of n−1 to the controller 50 as a response to the transmitted signal TS (refer to a signal waveform 68B3). The controller 50 outputs the Discharge to the P/H 48 at a timing of outputting the transmitted signal TS to reset an immediately preceding measurement value (refer to a signal waveform 68D3). The controller 50 performs A/D conversion on the second received signal RS2b that has responded to the detector coil 40 located at the position of n−1 and has been held in the P/H 48, thereby measuring the level of the second received signal RS2b after the A/D conversion (refer to a signal waveform 68C3).

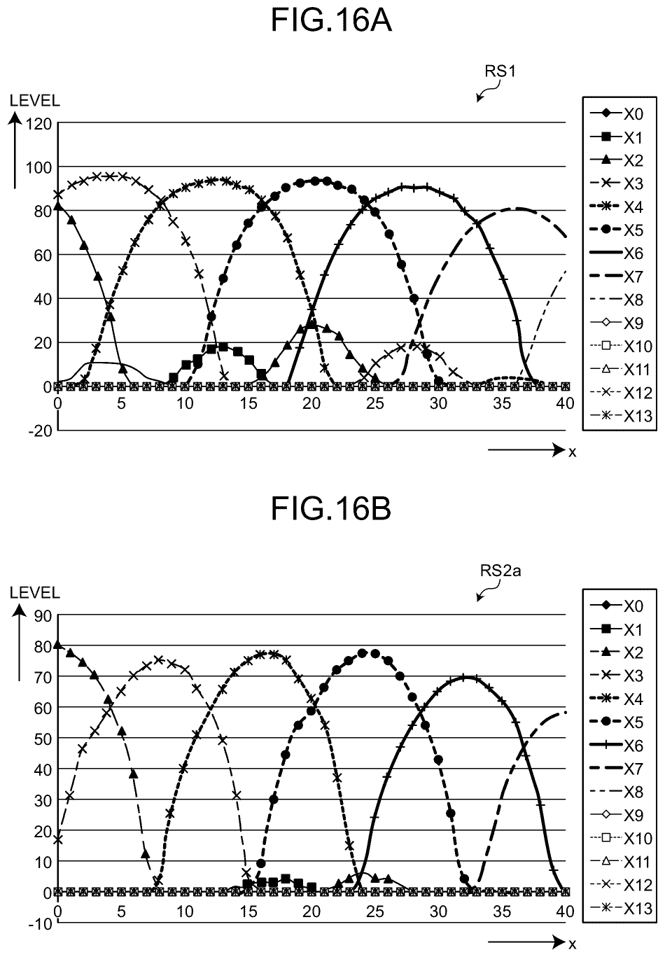

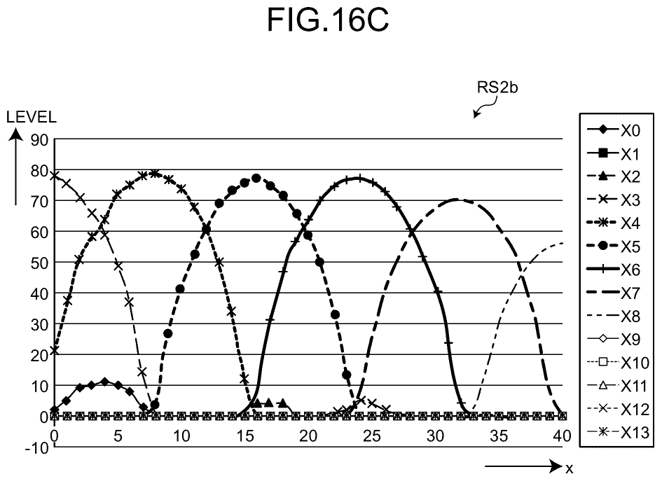

FIGS. 16A to 16C are explanatory diagrams of specific examples of the third position P3, the fourth position P4a, and the fourth position P4b specified from the first received signal RS1, the second received signal RS2a, and the second received signal RS2b, respectively. The fourth position P4a and the fourth position P4b are examples of the fourth position P4.

In FIGS. 16A to 16C, the horizontal axis represents the position of the placement surface 12A in the X-axis direction. The vertical axis represents the level of the received signal RS. In FIGS. 16A to 16C, X0 to X13 represent the levels of the received signals RS detected by the detector coils 40X arranged at the respective positions X0 to X13.

For example, a scene is assumed in which the first received signal RS1 detected by each of the detector coils 40, each of which serves as the output source of the transmitted signal TS, is the received signal RS illustrated in FIG. 16A. Then, a scene is assumed in which the controller 50 specifies the position X1 as the third position P3 by specifying the position P of the power receiving unit 22 by the basic position specifying processing using the above-described ratio based on the first received signal RS1 illustrated in FIG. 16A.

In addition, a scene is assumed in which the second received signal RS2a detected by each of the next detector coils 40 adjacent to the detector coils 40, each of which serves as the output source of the transmitted signal TS, is the received signal RS illustrated in FIG. 16B. Then, a scene is assumed in which the controller 50 specifies the position X2 as the fourth position P4a by specifying the position P of the power receiving unit 22 by the basic position specifying processing using the above-described ratio based on the second received signal RS2a illustrated in FIG. 16B.

In addition, a scene is assumed in which the second received signal RS2b detected by each of the previous detector coils 40 adjacent to the detector coils 40, each of which serves as the output source of the transmitted signal TS, is the received signal RS illustrated in FIG. 16C. Then, a scene is assumed in which the controller 50 specifies the position X3 as the fourth position P4b by specifying the position P of the power receiving unit 22 by the basic position specifying processing using the above-described ratio based on the second received signal RS2b illustrated in FIG. 16C.

In this case, the controller 50 specifies an accurate position P of the power receiving unit 22 based on the position X1, which is the third position P3, the position X2, which is the fourth position P4a, and the position X3, which is the fourth position P4b.

For example, the controller 50 obtains an average position of the position X1, which is the third position P3, the position X2, which is the fourth position P4a, and the position X3, which is the fourth position P4b, by the following Formula (1).

$$X = ( X 1 + X 2 + X 3 ) / 3 \qquad Formula ( 1 )$$

Then, the controller 50 specifies the position X, which is the average position calculated by Formula (1), as the accurate position P of the power receiving unit 22.

Note that the controller 50 is only required to calculate the position P of the power receiving unit 22 based on the third position P3 and the fourth position P4, and is not limited to a mode using the average position. For example, the controller 50 may specify, as the accurate position P of the power receiving unit 22, an average position calculated after weighting at least one of the third position P3 and the fourth position P4 in accordance with the relative distance or the like.

In addition, the controller 50 only needs to calculate the position of the power receiving unit 22 based on the third position P3 and the fourth position P4, and the number of the fourth positions P4 is not limited to two types of the fourth position P4a and the fourth position P4b, and may be one type or three or more types.

For example, the controller 50 may use, as the fourth position P4, only the position of n+1, namely, the second received signal RS2a detected by the next detector coil 40 adjacent to the detector coil 40 serving as the output source of the transmitted signal TS, as the second received signal RS2. Then, the controller 50 may specify the position X, which is an average position between third position P3 and fourth position P4a, as the accurate position P of the power receiving unit 22.

In addition, the controller 50 may use the second received signal RS2, which is the received signal RS detected by each of the detector coils 40 other than the output source of the transmitted signal TS, and is not limited to the form of using the received signal RS of the detector coil 40 adjacent to the detector coil 40 serving as the output source of the transmitted signal TS.

For example, the controller 50 may use, as the fourth position P4, the received signal RS detected by each of the two or more detector coils 40 arranged in a direction away from the detector coil 40 with respect to the detector coil 40 serving as the output source of the transmitted signal TS, as the second received signal RS.

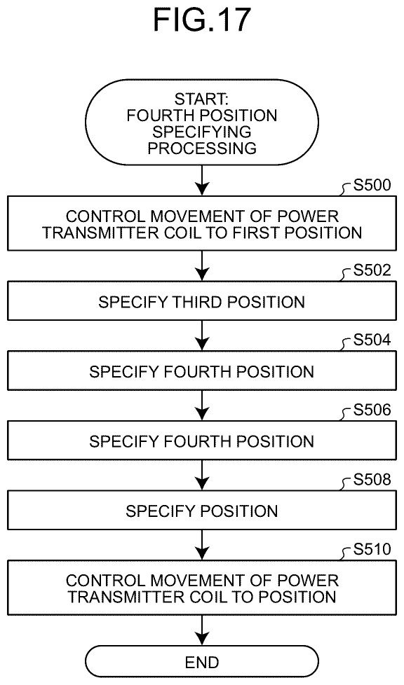

FIG. 17 is a flowchart illustrating an example of a procedure of the fourth position specifying processing executed by the controller 50.

The controller 50 controls the movement of the power transmitter coil 30 to the first position P1 specified in step S104 (refer to FIG. 9) (step S500). The processing in step S500 is similar to that in step S200 described above.

Next, the controller 50 specifies the third position P3 of the power receiving unit 22 (step S502). For example, the controller 50 selectively and sequentially outputs the transmitted signal TS to each of the detector coils 40. Then, the controller 50 detects the levels of the first received signals RS1 that are responded from the power receiving unit 22 in reaction to the magnetic field for detection and are detected by the detector coils 40 each serving as the output source of the transmitted signal TS. Then, based on the level of the first received signal RS1 detected by each of the detector coils 40, the controller 50 specifies the position P of the power receiving unit 22 by the basic position specifying processing using the above-described ratio, thereby specifying the third position P3.

Next, the controller 50 specifies the fourth position P4a of the power receiving unit 22 (step S504). For example, the controller 50 selectively and sequentially outputs the transmitted signal TS to each of the detector coils 40. Then, the controller 50 detects the levels of the second received signals RS2a that are responded from the power receiving unit 22 in reaction to the magnetic field for detection and are detected by the next detector coils 40 adjacent to the detector coils 40 each serving as the output source of the transmitted signal TS. Then, based on the level of the second received signal RS2a detected by each of the detector coils 40, the controller 50 specifies the position P of the power receiving unit 22 by the basic position specifying processing using the above-described ratio, thereby specifying the fourth position P4a.

Next, the controller 50 specifies the fourth position P4b of the power receiving unit 22 (step S506). For example, the controller 50 selectively and sequentially outputs the transmitted signal TS to each of the detector coils 40. Then, the controller 50 detects the levels of the second received signals RS2b that are responded from the power receiving unit 22 in reaction to the magnetic field for detection and are detected by the previous detector coils 40 adjacent to the detector coils 40 each serving as the output source of the transmitted signal TS. Then, based on the level of the second received signal RS2b detected by each of the detector coils 40, the controller 50 specifies the position P of the power receiving unit 22 by the basic position specifying processing using the above-described ratio, thereby specifying the fourth position P4b.

Next, the controller 50 specifies the accurate position P of the power receiving unit 22 by using the third position P3 specified in step S502, the fourth position P4a specified in step S504, and the fourth position P4b specified in step S506 (step S508). For example, the controller 50 specifies the average position of the third position P3, the fourth position P4a, and the fourth position P4b as the accurate position P of the power receiving unit 22.

Then, the controller 50 controls the movement of the power transmitter coil 30 to the position P specified in step S508 (step S510). Then, this routine is ended.

When the controller 50 executes the fourth position specifying processing illustrated in FIG. 17 as the position specifying processing in step S112 illustrated in FIG. 9, the charging control from the power transmitter coil 30 moved to the position P calculated as the accurate position P of the power receiving unit 22 to the power receiving unit 22 is started.

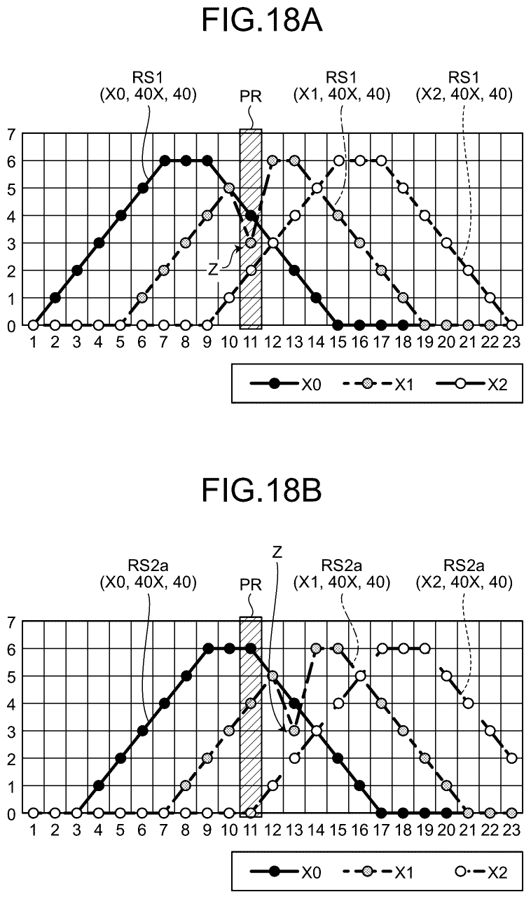

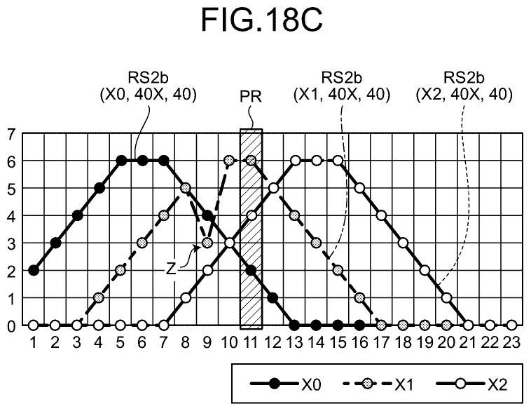

FIGS. 18A to 18C are explanatory diagrams of an example of the effect of the fourth position specifying processing.

In FIGS. 18A to 18C, the horizontal axis represents the position of the placement surface 12A in the X-axis direction. The vertical axis represents the level of the received signal RS. In FIGS. 18A to 18C, X0, X1, and X2 represent the levels of the received signals RS detected by the detector coils 40X respectively disposed at the positions X0, X1, and X2. FIGS. 18A to 18C illustrate a scene in which the power receiving unit 22 of the terminal device 20 is disposed at the position PR of “11 mm”.

FIG. 18A is an explanatory diagram of the first received signal RS1 detected by each of the detector coils 40 that have detected the received signal RS used for specifying the third position P3. FIG. 18B is an explanatory diagram of the second received signal RS2a detected by each of the detector coils 40 that have detected the received signal RS used for specifying the fourth position P4a. FIG. 18C is an explanatory diagram of the second received signal RS2b detected by each of the detector coils 40 that have detected the received signal RS used for specifying the fourth position P4b.

As illustrated in FIG. 18A, when the power receiving unit 22 of the terminal device 20 is disposed at the position PR of “11 mm”, an error occurs at the third position P3 calculated by using the first received signal RS1 received by the detector coil 40 disposed near the position PR due to the influence of noise Z.

On the other hand, the fourth position P4a and the fourth position P4b calculated by using each of the second received signal RS2a and the second received signal RS2b received by the other detector coil 40 different from the detector coil 40 serving as the output source of the transmitted signal TS do not include the error due to the influence of the noise Z (refer to FIGS. 18B and 18C).

Therefore, by specifying the position P of the power receiving unit 22 by using the third position P3, the fourth position P4a, and the fourth position P4b, the controller 50 can specify a more accurate position P in which the error due to the influence of the noise Z is reduced. For example, when the controller 50 specifies the average position of the third position P3, the fourth position P4a, and the fourth position P4b as the position P of the power receiving unit 22, the position P in which the influence of the noise Z is reduced to ⅓ can be specified.

As described above, since the fourth position specifying processing is effective in reducing the influence of the noise Z, the position of the power receiving unit 22 can be specified more effectively and with high accuracy with respect to the terminal device 20 in which the noise Z is more likely to occur.

As described above, the charging device 10 of the present embodiment wirelessly charges the terminal device 20 including the power receiving unit 22 (power receiver) that is placed on the placement surface 12A and receives the wirelessly transmitted power. The charging device 10 according to the present embodiment includes the power transmitter coil 30, the detector coils 40, the moving mechanism 36, and the controller 50. The power transmitter coil 30 transmits power to the terminal device 20. The detector coils 40 are coils for detecting the position of the power receiving unit 22 of the terminal device 20 placed on the placement surface 12A. The moving mechanism 36 moves the power transmitter coil 30. The controller 50 controls the power transmitter coil 30, the detector coils 40, and the moving mechanism 36. The controller 50 selectively and sequentially outputs the transmitted signals TS for generating the magnetic field for detection to the detector coils 40, and specifies the position P of the power receiving unit 22 based on the received signals RS that are responded from the power receiving unit 22 in reaction to the magnetic field for detection and are detected by the detector coils 40. The controller 50 specifies the position P of the power receiving unit 22 in accordance with a relative distance between the first position P1 of the power receiving unit 22, which is the position P specified based on the received signal RS, and the power transmitter coil 30.

As described above, the controller 50 of the charging device 10 of the present embodiment specifies the position P specified in accordance with the relative distance between the first position P1 of the power receiving unit 22 specified based on the received signal RS and the power transmitter coil 30 as the accurate position P of the power receiving unit 22.

Therefore, the charging device 10 of the present embodiment can specify the position P of the power receiving unit 22 with high accuracy in which the influence of the magnetic body sheet 32 and the like is suppressed as compared with a case in which the position P specified regardless of the relative distance is specified as the accurate position P of the power receiving unit 22.

Therefore, the charging device 10 of the present embodiment can specify the position P of the power receiving unit 22 of the terminal device 20 with high accuracy.

Note that, in the present embodiment, a mode has been described in which the controller 50 executes any one of the first position specifying processing, the second position specifying processing, the third position specifying processing, and the fourth position specifying processing when the relative distance between the first position of the power receiving unit 22 and the power transmitter coil 30 is out of the range of the predetermined distance.

Which position specifying processing the controller 50 executes may be determined in advance. For example, the controller 50 may execute position specifying processing set in advance by a user or the like among the first position specifying processing, the second position specifying processing, the third position specifying processing, and the fourth position specifying processing. In addition, information indicating which position specifying processing is executed may be appropriately changed in accordance with an operation instruction or the like through an operation unit by the user.

### First Modification

In the above embodiment, a mode has been described in which the controller 50 of the charging device 10 executes any position specifying processing of the first position specifying processing, the second position specifying processing, the third position specifying processing, and the fourth position specifying processing when the relative distance between the first position P1 of the power receiving unit 22 and the power transmitter coil 30 is out of the range of the predetermined distance.

However, when the relative distance between the first position P1 of the power receiving unit 22 and the power transmitter coil 30 is out of the range of the predetermined distance, the controller 50 may execute two or more of the first position specifying processing, the second position specifying processing, the third position specifying processing, and the fourth position specifying processing in combination.

For example, the controller 50 may execute each of the first position specifying processing, the second position specifying processing, and the third position specifying processing in combination with the fourth position specifying processing.

In the first position specifying processing and the second position specifying processing, as described above, the controller 50 specifies the second position P2, which is the position of the power receiving unit 22 specified based on the received signal RS detected in response to the transmitted signal TS output in a state where the power transmitter coil 30 is present at the first position P1, as the formal position P of the power receiving unit 22. The controller 50 may execute the fourth position specifying processing in combination at the time of specifying at least one of the first position P1 and the second position P2 in the first position specifying processing and the second position specifying processing.

In this case, the controller 50 may use the fourth position specifying processing of specifying the position P of the power receiving unit 22 based on the third position P3 and the fourth position P4 instead of the basic position specifying processing using the ratio described above as specifying processing of at least one of the first position P1 and the second position P2. Specifically, the controller 50 executes the processing of steps S502 to S508 (refer to FIG. 17) in the fourth position specifying processing during at least one of the specifying processing of the first position P1 in step S104 (refer to FIG. 9), the specifying processing of the second position P2 in step S202 (refer to FIG. 10), and the specifying processing of the second position P2 in step S310 (refer to FIG. 12). Through these types of processing, the controller 50 executes the fourth position specifying processing in combination at the time of specifying at least one of the first position P1 and the second position P2 in the first position specifying processing and the second position specifying processing.

Further, for example, the controller 50 may execute the fourth position specifying processing in combination with the specifying processing of the position P using the corrected received signal (refer to step S402 in FIG. 13A) in the third position specifying processing using the correction coefficient Ke. Specifically, the controller 50 executes the processing of steps S502 to S508 (refer to FIG. 17) in the fourth position specifying processing during the specifying processing of the first position P1 in step S104 (refer to FIG. 9). Then, the controller 50 may execute the third position specifying processing illustrated in FIG. 13A by using the first position P1 specified by the fourth position specifying processing.

As described above, the controller 50 may execute each of the first position specifying processing, the second position specifying processing, and the third position specifying processing in combination with the fourth position specifying processing.

### Second Modification

In addition, the controller 50 may execute the third position specifying processing using the correction coefficient Ke in combination with each of the first position specifying processing and the second position specifying processing.

In this case, when the relative distance is out of the range of the predetermined distance, the controller 50 may specify the accurate position P of the power receiving unit 22 based on the corrected received signal obtained by correcting the received signal RS used for specifying at least one of the first position P1 and the second position P2 by the correction coefficient Ke corresponding to the relative distance.

Specifically, as the specifying processing of at least one of the first position P1 and the second position P2, the controller 50 may execute the position specifying processing using the corrected received signal obtained by correcting the received signal RS with the correction coefficient Ke corresponding to the relative distance instead of the received signal RS during the basic position specifying processing using the ratio described above.

### Third Modification

In the above embodiment, a mode in which the controller 50 executes the first position specifying processing when the relative distance between the first position of the power receiving unit 22 and the power transmitter coil 30 is out of the range of the predetermined distance has been described as an example.

However, the controller 50 may execute the first position specifying processing regardless of whether the relative distance is out of the range of the predetermined distance. That is, after specifying the first position P1, the controller 50 may control the movement of the power transmitter coil 30 to the first position P1, and may specify the second position P2, which is the position of the power receiving unit 22 specified based on the received signal RS that is detected in response to the transmitted signal TS output in a state where the power transmitter coil 30 is present at the first position P1, as the accurate position P of the power receiving unit 22.

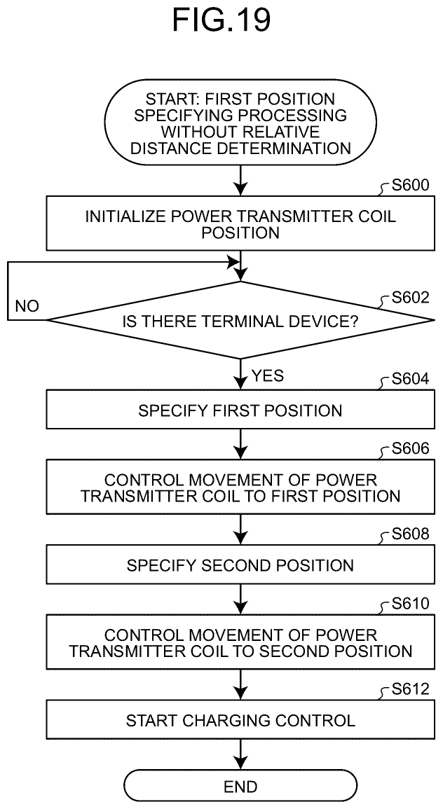

FIG. 19 is a flowchart illustrating an example of a procedure of information processing executed by the controller 50 of the present modification.

The controller 50 initializes the position of the power transmitter coil 30 (step S600). Next, the controller 50 determines whether the terminal device 20 is placed on the placement surface 12A (step S602). The controller 50 repeats a negative determination (step S602: No) until an affirmative determination is made in step S602 (step S602: Yes). When the controller 50 makes an affirmative determination in step S602 (step S602: Yes), the processing proceeds to step S604. In step S604, the controller 50 specifies the first position P1 of the power receiving unit 22 (step S604).

The processing in steps S600 to S604 is similar to that in steps S100 to S104 (refer to FIG. 9).

Next, the controller 50 controls the movement of the power transmitter coil 30 to the first position P1 specified in step S604 (step S606). Then, the controller 50 specifies the second position P2 of the power receiving unit 22 (step S608). Next, the controller 50 controls the movement of the power transmitter coil 30 to the second position P2 specified in step S608 (step S610). The processing in steps S606 to S610 is similar to that in steps S200 to S204 (refer to FIG. 10).

Then, the controller 50 starts charging control in the same manner as in step S114 (refer to FIG. 9) (step S612), and ends this routine.

As described above, in the present modification, the controller 50 executes the first position specifying processing regardless of whether the relative distance is out of the range of the predetermined distance.

In the first position specifying processing, the power transmitter coil 30 is controlled to move to the first position P1 temporarily specified as the position P of the power receiving unit 22, and the second position P2 specified based on the received signal RS detected in response to the transmitted signal TS output in a state where the power transmitter coil 30 is present at the first position P1 is specified as the formal position P of the power receiving unit 22.

Since the second position P2 is specified based on the received signal RS detected in response to the transmitted signal TS output in a state where the power transmitter coil 30 is present at the first position P1, the controller 50 can specify the second position P2 in a state where the influence of the sensitivity gradient by the magnetic body sheet 32 is suppressed. Therefore, by executing the first position specifying processing, the controller 50 can specify the position P of the power receiving unit 22 of the terminal device 20 with higher accuracy as compared with a case in which the first position P1 is specified as the formal position P of the power receiving unit 22.

Therefore, in the present modification as well, similarly to the above-described embodiment, the charging device 10 can specify the position of the power receiving unit 22 of the terminal device 20 with high accuracy.

Similarly to the first modification and the second modification, the controller 50 may execute the first position specifying processing in combination with at least one of the third position specifying processing and the fourth position specifying processing.

### Fourth Modification

In the above embodiment, the mode in which the controller 50 executes the second position specifying processing when the relative distance between the first position of the power receiving unit 22 and the power transmitter coil 30 is out of the range of the predetermined distance has been described as an example.

However, the controller 50 may execute the second position specifying processing regardless of whether the relative distance is out of the range of the predetermined distance. That is, after specifying the first position P1, the controller 50 starts charging control from the power transmitter coil 30 to the power receiving unit 22 after controlling the movement of the power transmitter coil 30 to the first position P1. When the terminal device 20 that has started the charging control is a predetermined terminal device determined in advance, the controller 50 stops the charging control. The controller 50 specifies the second position P2, which is the position P of the power receiving unit 22 specified based on the received signal RS detected in response to the transmitted signal TS output in the state where the power transmitter coil 30 is present at the first position P1, as the accurate position P of the power receiving unit 22.

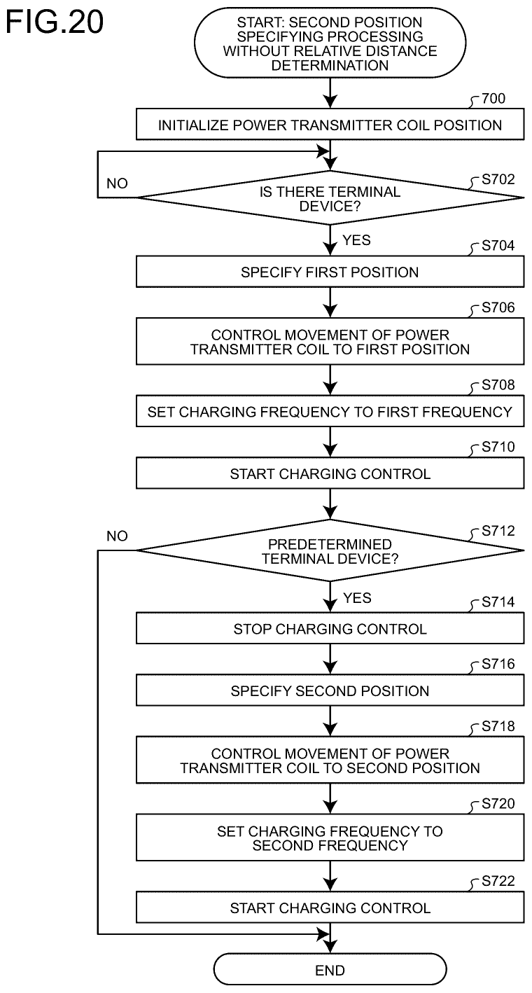

FIG. 20 is a flowchart illustrating an example of a procedure of information processing executed by the controller 50 of the present modification.

The controller 50 initializes the position of the power transmitter coil 30 (step S700). Next, the controller 50 determines whether the terminal device 20 is placed on the placement surface 12A (step S702). The controller 50 repeats a negative determination (step S702: No) until an affirmative determination is made in step S702 (step S702: Yes). When the controller 50 makes an affirmative determination in step S702 (step S702: Yes), the processing proceeds to step S704. In step S704, the controller 50 specifies the first position P1 of the power receiving unit 22 (step S704).

The processing in steps S700 to S704 is similar to that in steps S100 to S104 (refer to FIG. 9).

Next, the controller 50 controls the movement of the power transmitter coil 30 to the first position P1 specified in step S704 (step S706). Next, the controller 50 sets a charging frequency to a first frequency (step S708). Then, the controller 50 applies the AC voltage of the first frequency set in step S708 to the power transmitter coil 30, and starts charging control from the power transmitter coil 30 to the power receiving unit 22 (step S710).

Next, the controller 50 determines whether the terminal device 20 including the power receiving unit 22 that has started charging in step S710 is a predetermined terminal device (step S712). Upon determining that the terminal device is not the predetermined terminal device (step S712: No), the controller 50 ends this routine. Therefore, in a case of negative determination in step S712, the controller 50 continues the charging control started in step S710. On the other hand, upon determining that the terminal device is the predetermined terminal device (step S712: Yes), the controller 50 proceeds to step S713.

In step S714, the controller 50 stops the charging control started in step S710 (step S714), and proceeds to step S716. In step S716, the controller 50 specifies the second position P2 of the power receiving unit 22 (step S716). The controller 50 then controls the movement of the power transmitter coil 30 to the second position P2 specified in step S716 (step S718). Then, the controller 50 sets the charging frequency to a second frequency (step S720).

The processing in steps S706 to S720 is similar to that in steps S300 to S314 (refer to FIG. 12).

Then, the controller 50 starts the charging control in the same manner as in step S114 (refer to FIG. 9) by the power of the second frequency set in step S720 (step S722), and ends this routine.

As described above, in the present modification, the controller 50 executes the second position specifying processing regardless of whether the relative distance is out of the range of the predetermined distance.

In the second position specifying processing, since the second position P2 is specified based on the received signal RS detected in response to the transmitted signal TS output in a state where the power transmitter coil 30 is present at the first position P1, the controller 50 can specify the second position P2 in a state where the influence of a sensitivity variation due to the magnetic body sheet 32 is suppressed. Therefore, by executing the second position specifying processing, the controller 50 can specify the position of the power receiving unit 22 of the terminal device 20 with higher accuracy as compared with a case in which the first position P1 is specified as the formal position P of the power receiving unit 22.

Therefore, in the present modification as well, similarly to the above-described embodiment, the charging device 10 can specify the position of the power receiving unit 22 of the terminal device 20 with high accuracy.

Similarly to the first modification and the second modification, the controller 50 may execute the second position specifying processing in combination with at least one of the third position specifying processing and the fourth position specifying processing.

### Fifth Modification

In the above embodiment, the mode in which the controller 50 executes the third position specifying processing when the relative distance between the first position of the power receiving unit 22 and the power transmitter coil 30 is out of the range of the predetermined distance has been described as an example.

However, the controller 50 may execute the third position specifying processing regardless of whether the relative distance is out of the range of the predetermined distance. That is, after specifying the first position P1, the controller 50 may specify the accurate position P of the power receiving unit 22 based on the corrected received signal obtained by correcting the received signal RS used for specifying the first position P1 with the correction coefficient Ke corresponding to the relative distance.

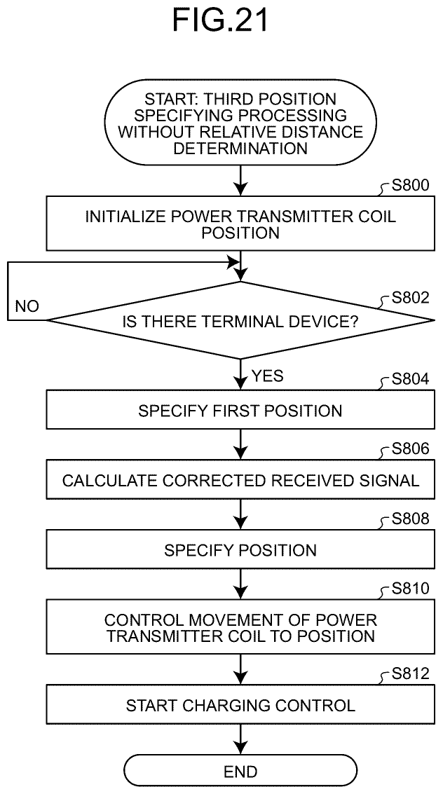

FIG. 21 is a flowchart illustrating an example of a procedure of information processing executed by the controller 50 of the present modification.

The controller 50 initializes the position of the power transmitter coil 30 (step S800). Next, the controller 50 determines whether the terminal device 20 is placed on the placement surface 12A (step S802). The controller 50 repeats a negative determination (step S802: No) until an affirmative determination is made in step S802 (step S802: Yes). When the controller 50 makes an affirmative determination in step S802 (step S802: Yes), the processing proceeds to step S804. In step S804, the controller 50 specifies the first position P1 of the power receiving unit 22 (step S804).

The processing in steps S800 to S804 is similar to that in steps S100 to S104 (refer to FIG. 9).

Next, the controller 50 calculates a corrected received signal obtained by correcting the received signal RS used for specifying the first position P1 specified in step S804 with the correction coefficient Ke corresponding to the relative distance between the first position P1 and the power transmitter coil 30 (step S806).

Next, the controller 50 specifies the position P of the power receiving unit 22 by using the corrected received signal calculated in step S806 (step S808). That is, the controller 50 re-specifies the position P of the power receiving unit 22 by using the corrected received signal obtained by correcting the received signal RS used for specifying the first position P1. Then, the controller 50 performs control the movement of the power transmitter coil 30 to the position P specified in step S808 (step S810).

The processing in steps S806 to S810 is similar to that in steps S400 to S404 (refer to FIG. 13A).

Then, the controller 50 starts charging control in the same manner as in step S114 (refer to FIG. 9) (step S812), and ends this routine.

As described above, in the present modification, the controller 50 executes the third position specifying processing regardless of whether the relative distance is out of the range of the predetermined distance.

In the third position specifying processing, the controller 50 specifies the position P of the power receiving unit 22 based on the corrected received signal obtained by correcting the received signal RS used for specifying the first position P1 temporarily specified as the position P of the power receiving unit 22 by the correction coefficient Ke corresponding to the relative distance. Then, the controller 50 specifies the position P of the power receiving unit 22 specified based on the corrected received signal as the formal position P of the power receiving unit 22.

That is, the controller 50 specifies the position P of the power receiving unit 22 by using the corrected received signal in which the influence of the sensitivity gradient by the magnetic body sheet 32 is canceled out. Therefore, the controller 50 can specify the position of the power receiving unit 22 of the terminal device 20 with high accuracy.

Therefore, in the present modification as well, similarly to the above-described embodiment, the charging device 10 can specify the position of the power receiving unit 22 of the terminal device 20 with high accuracy.

Similarly to the first modification, the controller 50 may execute the third position specifying processing in combination with the fourth position specifying processing.

### Sixth Modification

In the above embodiment, the mode in which the controller 50 executes the fourth position specifying processing when the relative distance between the first position of the power receiving unit 22 and the power transmitter coil 30 is out of the range of the predetermined distance has been described as an example.

However, the controller 50 may execute the fourth position specifying processing regardless of whether the relative distance is out of the range of the predetermined distance. That is, controller 50 may specify the accurate position P of the power receiving unit 22 based on the third position P3 and the fourth position P4.

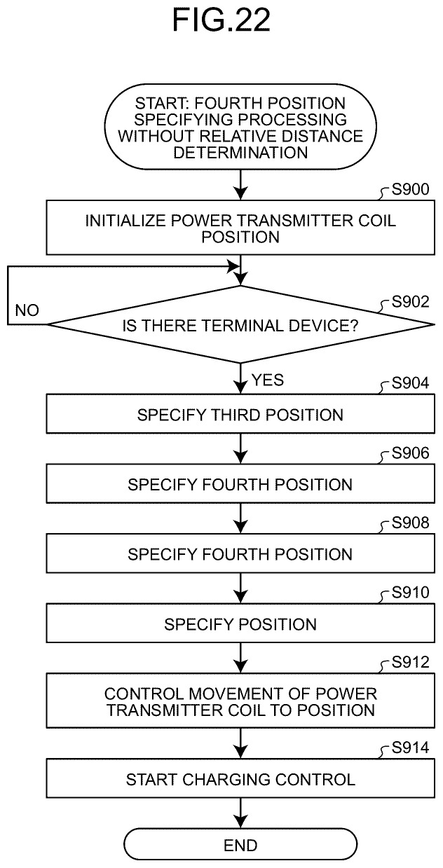

FIG. 22 is a flowchart illustrating an example of a procedure of information processing executed by the controller 50 of the present modification.

The controller 50 initializes the position of the power transmitter coil 30 (step S900). Next, the controller 50 determines whether the terminal device 20 is placed on the placement surface 12A (step S902). The controller 50 repeats a negative determination (step S902: No) until an affirmative determination is made in step S902 (step S902: Yes). When the controller 50 makes an affirmative determination in step S902 (step S902: Yes), the processing proceeds to step S904.

The processing in steps S900 to S902 is similar to that in steps S100 to S102 (refer to FIG. 9).

Then, the controller 50 executes the processing of steps S904 to S912 in the same manner as in steps S502 to S510 (refer to FIG. 17).

Specifically, the controller 50 specifies the third position P3 of the power receiving unit 22 (step S904). For example, the controller 50 selectively and sequentially outputs the transmitted signal TS to each of the detector coils 40. Then, the controller 50 detects the level of the first received signal RS1 that is responded from the power receiving unit 22 in reaction to the magnetic field for detection and is detected by the detector coil 40 serving as the output source of the transmitted signal TS. Then, based on the level of the first received signal RS1 detected by each of the detector coils 40, the controller 50 specifies the position P of the power receiving unit 22 by the basic position specifying processing using the above-described ratio, thereby specifying the third position P3.

Next, the controller 50 specifies the fourth position P4a of the power receiving unit 22 (step S906). For example, the controller 50 selectively and sequentially outputs the transmitted signal TS to each of the detector coils 40. Then, the controller 50 detects the levels of the second received signals RS2a that are responded from the power receiving unit 22 in reaction to the magnetic field for detection and are detected by the next detector coils 40 adjacent to the detector coils 40 each serving as the output source of the transmitted signal TS. Then, based on the level of the second received signal RS2a detected by each of the detector coils 40, the controller 50 specifies the position P of the power receiving unit 22 by the basic position specifying processing using the above-described ratio, thereby specifying the fourth position P4a.

Next, the controller 50 specifies the fourth position P4b of the power receiving unit 22 (step S908). For example, the controller 50 selectively and sequentially outputs the transmitted signal TS to each of the detector coils 40. Then, the controller 50 detects the levels of the second received signals RS2b that are responded from the power receiving unit 22 in reaction to the magnetic field for detection and are detected by the previous detector coils 40 adjacent to the detector coils 40 each serving as the output source of the transmitted signal TS. Then, based on the level of the second received signal RS2b detected by each of the detector coils 40, the controller 50 specifies the position P of the power receiving unit 22 by the basic position specifying processing using the above-described ratio, thereby specifying the fourth position P4b.

Next, the controller 50 specifies the accurate position P of the power receiving unit 22 by using the third position P3 specified in step S904, the fourth position P4a specified in step S906, and the fourth position P4b specified in step S908 (step S910). For example, the controller 50 specifies the average position of the third position P3, the fourth position P4a, and the fourth position P4b as the accurate position P of the power receiving unit 22.

Then, the controller 50 controls the movement of the power transmitter coil 30 to the position P specified in step S910 (step S912). Then, the controller 50 starts charging control in the same manner as in step S114 (refer to FIG. 9) (step S914), and ends this routine.

As described above, in the present modification, the controller 50 executes the fourth position specifying processing regardless of whether the relative distance is out of the range of the predetermined distance.

In the fourth specifying processing, the accurate position P of the power receiving unit 22 is specified based on the third position P3 and the fourth position P4. The third position P3 is a position P specified based on the first received signal RS1, which is the received signal RS detected by each of the detector coils 40 each serving as the output source of the transmitted signal TS, in response to the transmitted signal TS sequentially output to each of the detector coils 40. The fourth position P4 is a position P specified based on the second received signal RS2, which is the received signal RS detected by each of the detector coils 40 other than the output source of the transmitted signal TS, in response to the transmitted signal TS sequentially output to each of the detector coils 40.

Therefore, when the controller 50 specifies the accurate position P of the power receiving unit 22 by using the third position P3 and the fourth position P4, the position P in which the influence of the noise Z included in the received signal RS is reduced can be specified as the accurate position P of the power receiving unit 22.

Therefore, in the present modification as well, similarly to the above-described embodiments, the charging device 10 can specify the position of the power receiving unit 22 of the terminal device 20 with high accuracy.

The controller 50 may execute the third position specifying processing using the correction coefficient Ke in combination with the fourth position specifying processing.

In this case, the controller 50 may specify the accurate position P of the power receiving unit 22 based on the corrected received signal obtained by correcting the received signal RS used for specifying at least one of the third position P3 and the fourth position P4 with the correction coefficient Ke corresponding to the relative distance.

Specifically, as the specifying processing of at least one of the third position P3 and the fourth position P4, the controller 50 may execute the position specifying processing using the corrected received signal obtained by correcting the received signal RS with the correction coefficient Ke corresponding to the relative distance instead of the received signal RS during the basic position specifying processing using the ratio described above.

Although the embodiment and the modification have been described above, the embodiment and the modification have been presented as examples, and are not intended to limit the scope of the invention. The above-described novel embodiments and modifications can be implemented in various other forms, and various omissions, substitutions, and changes can be made without departing from the gist of the invention. The embodiments and modifications are included in the scope or gist of the invention, and are included in the invention described in the claims and the scope equivalent thereto.

What is claimed is:

1. A charging device wirelessly charging a terminal device placed on a placement surface, the terminal device including a power receiver receiving wirelessly transmitted power, the charging device comprising:
a power transmitter coil configured to transmit power to the terminal device;
detector coils provided for detecting a position of the power receiver of the terminal device on the placement surface;
a moving mechanism configured to move the power transmitter coil; and
a controller configured to
control the power transmitter coil, the detector coils, and the moving mechanism,
output a transmitted signal for generating a magnetic field for detection, the transmitted signal being output selectively and sequentially to each of the detector coils, and
specify the position of the power receiver based on received signals, the received signals being responded from the power receiver in reaction to the magnetic field of detection and being detected by each of the detector coils,
wherein the controller is configured to specify the position of the power receiver in accordance with a relative distance between a first position of the power receiver and the power transmitter coil, the first position being the position of the power receiver specified based on the received signals.

2. The charging device according to claim 1, wherein the controller is configured to, when the relative distance is out of a range of a predetermined distance,
control movement of the power transmitter coil to the first position, and
specify, as the position of the power receiver, a second position being the position of the power receiver specified based on the received signals detected in response to the transmitted signals output in a state where the power transmitter coil is present at the first position.

3. The charging device according to claim 1, wherein the controller is configured to,
when the relative distance is out of a range of a predetermined distance, start charging control from the power transmitter coil to the power receiver after controlling movement of the power transmitter coil to the first position,
stop the charging control when the terminal device that has started the charging control is a predetermined terminal device set in advance, and
specify, as the position of the power receiver, a second position being the position of the power receiver specified based on the received signals detected in response to the transmitted signals output in a state where the power transmitter coil is present at the first position.

4. The charging device according to claim 3, wherein the predetermined terminal device is a magnet-mounted terminal device in which a magnet is disposed on at least part of an outer periphery of the power receiver.

5. The charging device according to claim 3, wherein the controller is configured to,
after controlling the movement of the power transmitter coil to the first position, start the charging control of power of a first frequency from the power transmitter coil to the power receiver, and,
after controlling the movement of the power transmitter coil to the second position, start the charging control of power of a second frequency higher than the first frequency from the power transmitter coil to the power receiver.

6. The charging device according to claim 1, wherein the controller is configured to, when the relative distance is out of a range of a predetermined distance, specify the position of the power receiver based on corrected received signals obtained by correcting the received signals used for specifying the first position with a correction coefficient corresponding to the relative distance.

7. The charging device according to claim 1, wherein
the controller is configured to, when the relative distance is out of a range of a predetermined distance, specify the position of the power receiver based on a third position and a fourth position,
the third position is the position of the power receiver specified based on first received signals, the first received signals being received signals respectively detected by the detector coils serving as output sources of the transmitted signals in response to the transmitted signals sequentially output to the detector coils, and
the fourth position is the position of the power receiver specified based on second received signals, the second received signals being received signals respectively detected by the detector coils other than the output sources of the transmitted signals in response to the transmitted signals sequentially output to the detector coils.

8. The charging device according to claim 2, wherein
the controller is configured to, when the relative distance is out of a range of a predetermined distance, specify the position of the power receiver based on a third position and a fourth position,
the third position is the position of the power receiver specified based on first received signals, the first received signals being received signals respectively detected by the detector coils serving as output sources of the transmitted signals in response to the transmitted signals sequentially output to the detector coils, and
the fourth position is the position of the power receiver specified based on second received signals, the second received signals being received signals respectively detected by the detector coils other than the output sources of the transmitted signals in response to the transmitted signals sequentially output to the detector coils.

9. The charging device according to claim 3, wherein
the controller is configured to, when the relative distance is out of a range of a predetermined distance, specify the position of the power receiver based on a third position and a fourth position,
the third position is the position of the power receiver specified based on first received signals, the first received signals being received signals respectively detected by the detector coils serving as output sources of the transmitted signals in response to the transmitted signals sequentially output to the detector coils, and
the fourth position is the position of the power receiver specified based on second received signals, the second received signals being received signals respectively detected by the detector coils other than the output sources of the transmitted signals in response to the transmitted signals sequentially output to the detector coils.

10. The charging device according to claim 6, wherein
the controller is configured to, when the relative distance is out of a range of a predetermined distance, specify the position of the power receiver based on a third position and a fourth position,
the third position is the position of the power receiver specified based on first received signals, the first received signals being received signals respectively detected by the detector coils serving as output sources of the transmitted signals in response to the transmitted signals sequentially output to the detector coils, and
the fourth position is the position of the power receiver specified based on second received signals, the second received signals being received signals respectively detected by the detector coils other than the output sources of the transmitted signals in response to the transmitted signals sequentially output to the detector coils.

11. The charging device according to claim 2, wherein the controller is configured to, when the relative distance is out of the range of the predetermined distance, specify the position of the power receiver based on corrected received signals obtained by correcting the received signals used for specifying at least one of the first position or the second position with a correction coefficient corresponding to the relative distance.

12. The charging device according to claim 3, wherein the controller is configured to, when the relative distance is out of the range of the predetermined distance, specify the position of the power receiver based on corrected received signals obtained by correcting the received signals used for specifying at least one of the first position or the second position with a correction coefficient corresponding to the relative distance.

13. A charging device wirelessly charging a terminal device placed on a placement surface, the terminal device including a power receiver receiving wirelessly transmitted power, the charging device comprising:
a power transmitter coil configured to transmit power to the terminal device;
detector coils provided for detecting a position of the power receiver of the terminal device on the placement surface;
a moving mechanism configured to move the power transmitter coil; and
a controller configured to
control the power transmitter coil, the detector coils, and the moving mechanism,
output a transmitted signal for generating a magnetic field for detection, the transmitted signal being output selectively and sequentially to each of the detector coils, and
specify the position of the power receiver based on received signals, the received signals being responded from the power receiver in reaction to the magnetic field of detection and being detected by each of the detector coils,
wherein the controller is configured to
control movement of the power transmitter coil to a first position of the power receiver, the first position being the position specified based on the received signals, and
specify, as the position of the power receiver, a second position being the position of the power receiver specified based on the received signals detected in response to the transmitted signals output in a state where the power transmitter coil is present at the first position.

14. A charging device wirelessly charging a terminal device placed on a placement surface, the terminal device including a power receiver receiving wirelessly transmitted power, the charging device comprising:
a power transmitter coil configured to transmit power to the terminal device;
detector coils for detecting a position of the power receiver of the terminal device on the placement surface;
a moving mechanism configured to move the power transmitter coil; and
a controller configured to
control the power transmitter coil, the detector coils, and the moving mechanism,
output a transmitted signal for generating a magnetic field for detection, the transmitted signal being output selectively and sequentially to each of the detector coils, and
specify the position of the power receiver based on received signals, the received signals being responded from the power receiver in reaction to the magnetic field of detection and being detected by each of the detector coils,
wherein the controller is configured to
start charging control from the power transmitter coil to the power receiver after controlling movement of the power transmitter coil to a first position of the power receiver, the first position being the position specified based on the received signals,
stop the charging control when the terminal device that has started the charging control is a predetermined terminal device set in advance, and
specify, as the position of the power receiver, a second position being the position of the power receiver specified based on the received signals detected in response to the transmitted signals output in a state where the power transmitter coil is present at the first position.

15. A charging device wirelessly charging a terminal device placed on a placement surface, the terminal device including a power receiver receiving wirelessly transmitted power, the charging device comprising:
a power transmitter coil configured to transmit power to the terminal device;
detector coils for detecting a position of the power receiver of the terminal device on the placement surface;
a moving mechanism configured to move the power transmitter coil; and
a controller configured to
control the power transmitter coil, the detector coils, and the moving mechanism,
output a transmitted signal for generating a magnetic field for detection, the transmitted signal being output selectively and sequentially to each of the detector coils, and
specify the position of the power receiver based on received signals, the received signals being responded from the power receiver in reaction to the magnetic field of detection and being detected by each of the detector coils,
wherein the controller is configured to specify the position of the power receiver based on corrected received signals obtained by correcting, with a correction coefficient, the received signals used for specifying a first position of the power receiver, the first position being the position of the power receiver specified based on the received signals, the correction coefficient corresponding to a relative distance between the first position and the detector coil.

16. A charging method implemented by a charging device wirelessly charging a terminal device placed on a placement surface, the terminal device including a power receiver receiving wirelessly transmitted power, the charging device including a power transmitter coil serving to transmit power to the terminal device, detector coils for detecting a position of the power receiver of the terminal device on the placement surface, and a moving mechanism serving to move the power transmitter coil, the charging method comprising:
controlling the power transmitter coil, the detector coils, and the moving mechanism,
outputting a transmitted signal for generating a magnetic field for detection, the transmitted signal being output selectively and sequentially to each of the detector coils, and
specifying the position of the power receiver based on received signals, the received signals being responded from the power receiver in reaction to the magnetic field of detection and being detected by each of the detector coils,
wherein the specifying of the position of the power receiver is performed by specifying the position of the power receiver in accordance with a relative distance between a first position of the power receiver and the power transmitter coil, the first position being the position of the power receiver specified based on the received signals.
